(19) United States
(12) Patent Application Publication
(10) Pub. No.: US 2026/0342954 A1
(43) Pub. Date: Oct. 29, 2026

(54) ADVANCED LIGHT FIELD IMAGE GENERATORS AND HYBRID LIGHT FIELD DISPLAY SYSTEMS

(71) Applicant: Looking Glass Factory, Inc., Brooklyn, NY (US)

(72) Inventors: Shawn Michael Frayne, Tampa, FL (US); Shiu Pong Lee, Quarry Bay (HK); Nitin Bhargava, Brooklyn, NY (US); Alexander Duncan, Brooklyn, NY (US); Wai Leung Fung, Brooklyn, NY (US); Oliver Garcia-Borg, Brooklyn, NY (US); Tung Yiu Fok, Sha Tin (HK); Robert Kodadek, Brooklyn, NY (US)

(73) Assignee: Looking Glass Factory, Inc., Brooklyn, NY (US)

(21) Appl. No.: 19/653,468

(22) Filed: Apr. 21, 2026

Related U.S. Application Data
(60) Provisional application No. 63/795,781, filed on Apr. 28, 2025.
(60) Provisional application No. 63/819,286, filed on Jun. 6, 2025.
(60) Provisional application No. 63/881,749, filed on Sep. 15, 2025.
(60) Provisional application No. 63/974,148, filed on Feb. 2, 2026.

(51) Int. Cl. H04N 13/312; H04N 13/00; H04N 13/315; H04N 13/351; H04N 13/359

(52) U.S. Cl. CPC H04N 13/312; H04N 13/315; H04N 13/351; H04N 13/359; H04N 2013/0077

(57) ABSTRACT

A hybrid light field display system includes a static light field image generator, a two-dimensional image generator, an illumination module, and a controller. In preferred variations, the static light field image generator embodies a three-dimensional scene by encoding a plurality of two-dimensional views corresponding to different perspectives of the three-dimensional scene, a plurality of ray samples of the three-dimensional scene, and/or another light field representation in one or more physical media layers. The static light field image generator can be combined with the two-dimensional image generator to present dynamic two-dimensional content visually coordinated with the three-dimensional scene.

### CROSS-REFERENCE TO RELATED APPLICATIONS

This application claims the benefit of U.S. Provisional Application number 63/795,781 filed 28, Apr. 2025, US Provisional Application number 63/819,286 filed 6, Jun. 2025, US Provisional Application number 63/881,749 filed 15, Sep. 2025 , and US Provisional Application number 63/974,148 filed 2, Feb. 2026, each of which is incorporated in its entirety by this reference.

This application is related to U.S. application Ser. No. 18/225,603 filed 24, Jul. 2023 and U.S. application Ser. No. 18/822,032 filed 30, Aug. 2024, each of which is incorporated in its entirety by this reference.

### TECHNICAL FIELD

This invention relates generally to display technologies, and more specifically to a new and useful display in the display field.

### BRIEF DESCRIPTION OF THE FIGURES

FIG. 1 shows a variant of an exemplary process flow chart for an encoding process.

FIG. 2 outlines a variant of how different perspectives along a horizontal line are captured from a 3D scene.

FIG. 3 illustrates an example of different encoding methods of different lenses.

FIG. 4 shows an example of an encoded image for the monochrome layer using the anisopic pixels encoding.

FIG. 5 shows an example of the encoding of the interlaced color layer.

FIG. 6 shows a realistic example of the stacked color and monochrome layers using the anisotropic pixel method.

FIG. 7 shows an illustrative example of two alternative placements of the darkened regions for the anisopic pixels.

FIG. 8 shows an example of the color strip method using an RGB color scheme and the anisopic pixel encoding method.

FIGS. 9A-9E shows variants of exemplary lens array combinations to enhance the lens performance.

FIG. 10 shows an example of some optional components that may be included in some embodiments of the display.

FIG. 11 shows an example of a hybrid light field display system.

FIG. 12 shows a variant of an illustration of an embodiment of the display.

FIG. 13A-13C shows variants of other illustrations of different embodiments of the display from different angles.

FIG. 14A shows an illustrative example of an exemplary application of the display in a home, where a live actor or recording of a person is displayed in a thin format display with apparent volume generated by the light field print layer.

FIG. 14B shows an illustrative example of an exemplary application of the display in an out-of-home advertising application, where a recording or live feed of a person is overlaid with 3D elements apparently floating out of the front surface of the display and print element.

FIGS. 15A-15B show variants of a wide and closeup view of another prototype of one embodiment of the display, demonstrating the application of shadows and reflections on the 2D display surface, that map to the 3D volume of the light field print for a convincing unified 2D display and 3D light field illusion.

FIGS. 16A-16F show examples of baseline optical stack variations.

FIG. 17 shows an example of content generation workflow.

FIGS. 18A-18B show examples of side view images of a variation of the system.

FIGS. 19A-19B show examples of side view images of a variation of the system showing shadow mapping.

FIG. 20 shows an example of a full parallax variation of the system.

FIG. 21 shows an example of another variation of the system.

FIG. 22 shows an example of another variation of the system with additional beneficial characteristics.

FIG. 23A-23C shows illustrative examples of drawings of applications of the system.

FIG. 24 shows an illustrative example of a 3D scene displayed through the static light field image generator, behind and around the shadow and reflection mapped 2D image and video content.

FIG. 25 is a schematic representation of a variant of the system.

FIGS. 26A-26C are schematic representations of variants of a roller-based variation of the system.

FIG. 27 is a schematic representation of a variant of an etched layer.

FIG. 28 is a schematic representation of a variant of the method.

FIG. 29 is an illustrative example of one or more switchable diffuser layer(s).

FIGS. 30A-30C are an illustrative example of a variant showing a targeted view, view-invariant shade and a modified view.

### DETAILED DESCRIPTION

The following description of the embodiments of the invention is not intended to limit the invention to these embodiments, but rather to enable any person skilled in the art to make and use this invention.

### 1. Overview

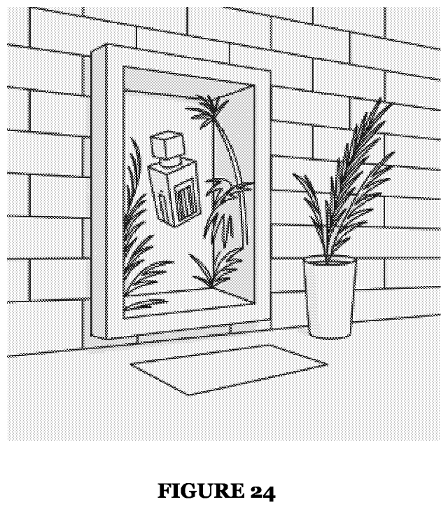

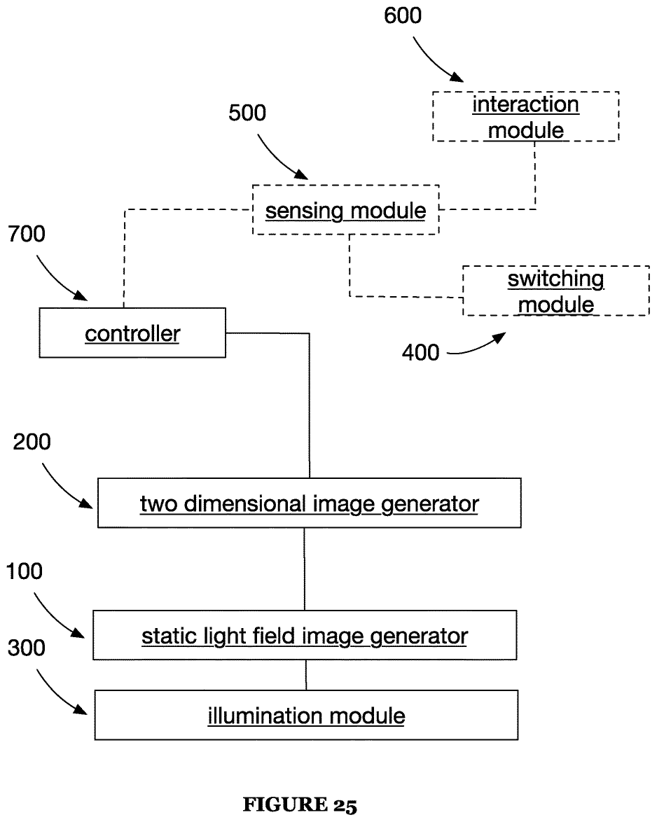

As shown for example in FIG. 25, the system can include: a static light field image generator 100; a two-dimensional image generator 200; an illumination module 300; an optional switching module 400; an optional sensing module 500; an optional interaction module 600; a controller 700; and/or any other suitable components. In preferred variations, the static light field image generator can embody a three-dimensional scene by encoding a plurality of two-dimensional views corresponding to different perspectives of the three-dimensional scene, a plurality of ray samples of the three-dimensional scene, and/or any other suitable light field representation in one or more physical media layers (example shown in FIG. 24). The system can be implemented as a home assistant device presenting an embodied agent in a three-dimensional alcove; a retail or out-of-home signage device providing attention-capturing three-dimensional reveals; a telepresence or conferencing device presenting a participant or agent within an apparent surrounding volume; a vehicle display or heads-up display presenting conventional indicators and immersive three-dimensional cues; a mobile or foldable device including a smaller hybrid display window, case-mounted module, or removable cover; and a decorative, museum, or educational display presenting themed scenes, artifacts, cutaways, and/or other volumetric media, and/or any other suitable product.

### 2. Technical Advantages

Variants of the technology can confer one or more advantages over conventional lenticular prints, holographic film exposures, Pepper's Ghost installations, shadow-box displays, switchable lenticular systems, and fully dynamic light field displays. More particularly, variants of this invention relates to systems and methods for generating advanced light field image generators, including high-resolution printed, exposed, etched, embossed, holographic, diffractive, emissive, and hybrid light field structures, and to hybrid display systems that combine a fixed or quasi-fixed light field scene with one or more two-dimensional display layers, switching layers, illumination systems, sensors, and control systems so as to present a group-viewable three-dimensional scene without requiring VR or AR headsets or three-dimensional glasses.

First, variants can provide substantially greater apparent depth than conventional low-resolution lenticular prints by combining high-resolution light field encoding with an optical steering structure. In preferred variations, the static light field image generator can achieve a high view count using a monochrome layer printed or exposed at significantly higher spatial resolution than commercially available color printers and, in some cases, significantly higher spatial resolution than commercially available display panels, thereby enabling a deeper, cleaner, and more convincing three-dimensional reconstruction than screen-based approaches using lower-resolution underlying modulators.

Second, variants can provide full-color or effectively full-color three-dimensional imagery while preserving the benefits of the high-resolution monochrome layer. In preferred variations, luma-rich spatial detail can be provided by a first layer and lower-resolution chroma information can be provided by a second layer, thereby leveraging the differing sensitivity of human vision to luminance and chrominance. This can enable a system that preserves high apparent depth and fine detail while still presenting convincing color, including embodiments in which the color information is provided by a lower-view-count light field color layer, a color strip arrangement, a color filter arrangement, and/or the dynamic two-dimensional display layer itself.

Third, variants can provide a convincing three-dimensional scene in a thin module. Unlike shadow-box displays and Pepper's Ghost systems, the device depth can be smaller than the apparent depth of the displayed scene. This can allow the system to create an apparent volume that visually extends behind a wall, panel, mirror, window, housing face, and/or other front surface of the display, and in some cases extends both behind and in front of the physical optical stack, while remaining suitable for wall-mounted, countertop, kiosk, vehicle, and consumer-device implementations.

Fourth, variants can operate with modest compute because a fixed or quasi-fixed three-dimensional scene can be physically encoded in the device, while only conventional two-dimensional media (e.g., 2D image, 2D video, 2D content, etc.) is rendered dynamically. Variants that only render the 2D media can reduce power, bandwidth, panel requirements, and rendering burden relative to fully dynamic light field displays. In preferred examples, conventional video playback, streaming, or interactive two-dimensional rendering pipelines can be used, because the system need not regenerate the entire three-dimensional light field in real time.

Fifth, variants can provide practical switching between two-dimensional and three-dimensional modes. This mode switching can improve usability in products that must sometimes prioritize readability of text and standard video, and at other times prioritize attention capture, immersion, or presence. In preferred variants, the system can support a true three-dimensional mode, a two-dimensional mode in which the three-dimensional scene is substantially reduced, washed out, cancelled, bypassed, flattened, or hidden, and/or one or more intermediate modes in which three-dimensional intensity is modulated. Such switching can be implemented, for example, using a controllable diffuser, a dual-illumination arrangement, a polarization-based nullification arrangement, an emissive washout arrangement, a retractable or repositionable layer, and/or a software-defined apparent-two-dimensional mode.

Sixth, variants can provide manufacturing pathways that are practical at a range of scales, including small bespoke units, consumer products, and large-format tiled installations. These pathways can include printing, film exposure, etching, embossing, lamination, post-lamination exposure mastering, calibration, and modular cartridge insertion.

Seventh, variants can provide application flexibility. The same core architecture can be deployed in static art objects, hybrid signage, telepresence systems, smart-home devices, vehicle displays, mirrored devices, mobile accessories, foldables, table-format gaming systems, educational exhibits, product displays, and/or any other suitable application. This flexibility can arise because the same core hybrid optical stack can be implemented as a standalone light field print, a hybrid print-plus-display module, a switchable two-dimensional/three-dimensional consumer device, a mirror-integrated device, a heads-up or reflected display, a window-in-window display region, and/or a large-format installation.

However, variants of the technology can confer any other suitable benefits and/or advantages.

### 3. System

As shown in FIG. 25, the system can include: a static light field image generator 100, a two-dimensional image generator 200, an illumination module 300, an optional switching module 400, an optional sensing module 500, an optional interaction module 600, and a controller 700. However, the system can additionally or alternatively include any other suitable components.

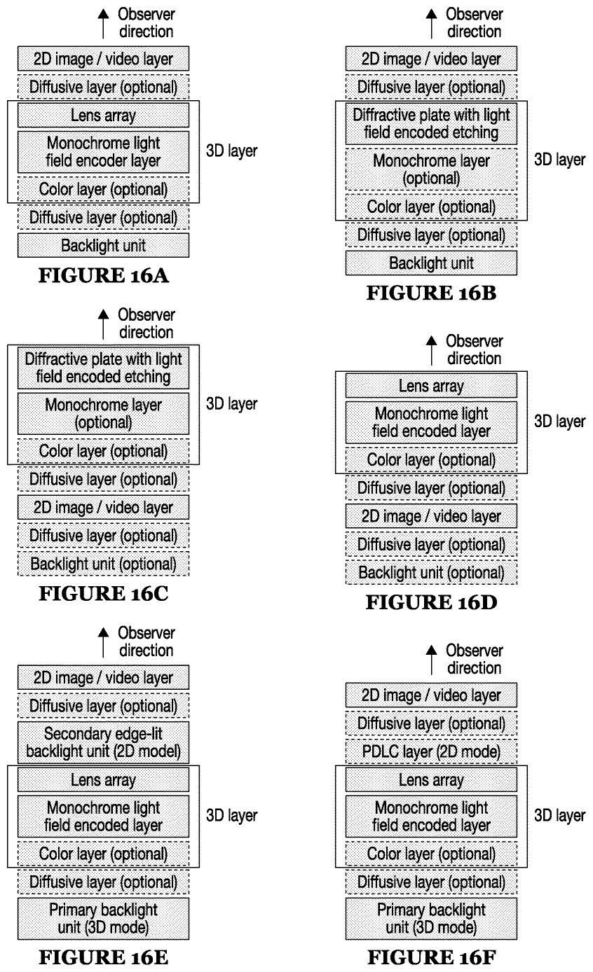

The system functions to generate a perceived three-dimensional scene using a static or quasi-static light field image generator. The system can additionally function to visually combine that three-dimensional scene with dynamic two-dimensional content, such that the dynamic content appears spatially coordinated with, embedded within, behind, in front of, and/or otherwise integrated with the three-dimensional scene (thereby resulting in a perception of 3D quality or characteristics in the 2D content). In variations, the system can further function to selectively operate in a three-dimensional mode, a two-dimensional mode, and/or one or more intermediate modes; to sense viewers, users, and/or environmental conditions; to receive interaction inputs; and/or to coordinate content playback, illumination, calibration, and optical-state changes across an optical stack (example shown in FIG. 16).

In a first variant, the system can include a static or quasi-static light field image generator that physically stores or otherwise embodies light field information in one or more media layers. The light field information can be encoded in a high-resolution monochrome print, a color print, a film exposure, an etched or embossed substrate, a holographic structure, a diffractive structure, a stimulus-responsive structure, an emissive structure, and/or any combination thereof. In preferred print-based examples, a high-resolution monochrome layer can encode grayscale light field information at a relatively high view count and/or ray count, and an optional color layer can encode color information at the same or a lower view count and/or ray count. The light field image generator can be configured to produce a deep three-dimensional scene, a floating volumetric effect, an apparent image located behind a front surface, an apparent image located in front of a front surface, a scene extending both behind and in front of the front surface, and/or any other suitable apparent spatial arrangement.

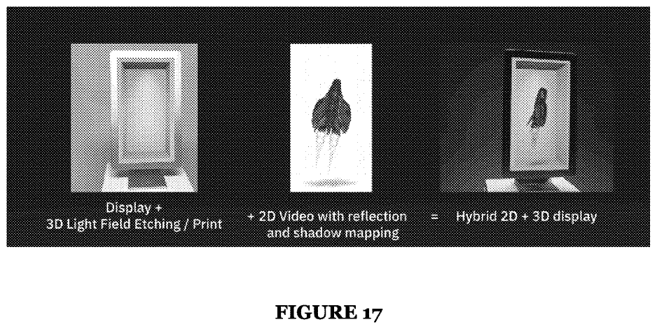

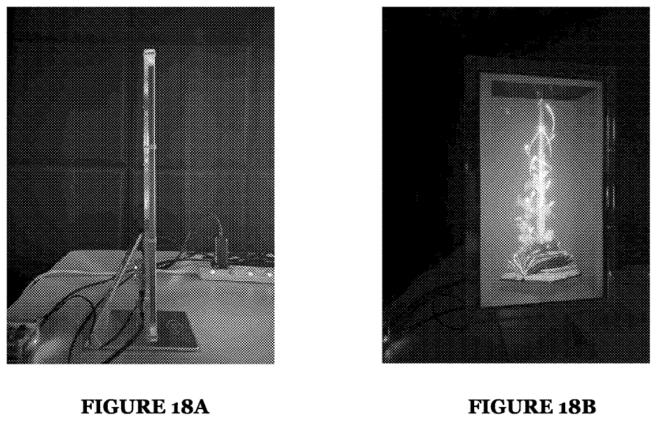

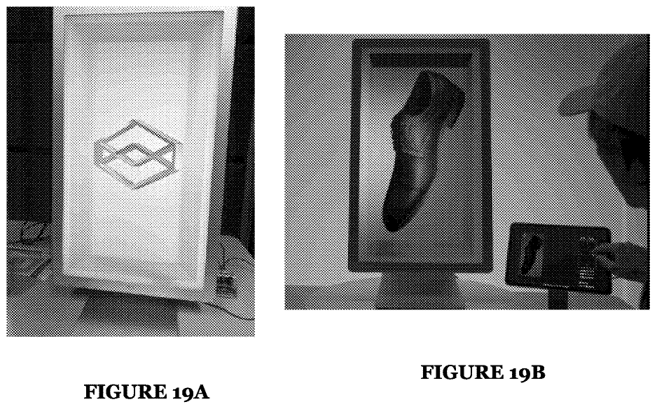

In a second variant, the system can include a hybrid display in which the static light field image generator is combined with a conventional two-dimensional display layer such as an LCD, open-cell LCD, OLED, transparent OLED, microLED, miniLED, electrophoretic display, projection surface, projector, persistence-of-vision display, and/or any other suitable display (examples are shown in FIGS. 17, 18, 19). In such variations, the static light field image generator can provide a persistent three-dimensional foreground, background, enclosure, alcove, stage, product volume, box, scene, world, and/or other spatial context, while the two-dimensional display can provide dynamic video, animated characters, recorded people, interactive user interface content, conversational agent embodiments, products, lighting cues, text, and/or any other suitable dynamic content. The two-dimensional display can be arranged behind the static light field image generator, in front of the static light field image generator, between portions of the static light field image generator (and/or static light field image generation stack), partially or fully enclosing the static light field generator (e.g., when the two-dimensional display includes a backlight unit and an open-cell display portion positioned on opposite sides of the static light field image generator), and/or in any other suitable optical relationship therewith. The combination can cause the dynamic content to appear visually embedded within, behind, in front of, and/or otherwise spatially coordinated with the three-dimensional scene. In specific examples, the dynamic content can be shadow-mapped (example shown in FIG. 19), reflection-mapped, geometrically deformed, brightness-adjusted, and/or otherwise coordinated with the three-dimensional scene to reinforce an apparent shared volume.

In a third variant, the system can be switchable between modes. For example, the system can operate in a three-dimensional mode in which the 3D image produced from the light field image generator is perceptible and provides multi-view depth cues; a two-dimensional mode in which the three-dimensional scene is substantially reduced, washed out, cancelled, bypassed, or hidden so that the system behaves substantially like a conventional two-dimensional display; and/or one or more intermediate modes in which the apparent three-dimensional intensity is partially retained or gradually changed. These transitions can be implemented optically, electronically, mechanically, computationally, and/or with any suitable combination. The display system is preferably configured to switch between the two-dimensional mode and the three-dimensional mode without perceptible transients (e.g., a smooth transition that one or more viewers do not find jarring, unexpected, result in perceptional whiplash, etc.). In an example, the switching or nullification system can include a controllable diffuser, a dual-illumination arrangement, a polarization-based nullification arrangement, an emissive washout arrangement, a repositionable layer, a retractable layer, a software-defined apparent-two-dimensional mode, and/or any other suitable mechanism along or in combination. A controller can initiate such transitions in response to user input, sensing, schedule, content-associated identifiers, metadata, and/or any other suitable trigger.

In a fourth stack variation, the system can include, in rear-to-front order, a backlight, an optional diffuser, a two-dimensional display layer, and the static light field image generator. In this arrangement, the static light field image generator can create a multi-view three-dimensional environment, and the two-dimensional display layer can modulate and/or provide dynamic content that appears within that environment. In other variations, the system can include, in rear-to-front order, a backlight, an optional diffuser, the static light field image generator, and the two-dimensional display layer, such that the two-dimensional display layer is positioned nearer to the viewer than the static light field image generator to increase apparent sharpness of two-dimensional content when UI readability, small text, and/or high-frequency dynamic video detail are prioritized. In additional variations, the entire hybrid optical stack can be viewed directly and/or through a reflective combiner. In reflected variations, content can be pre-warped and/or inverted so that after reflection it appears correctly oriented and at a desired virtual distance. Such variations can be used in heads-up displays, vehicle dashboards, product overlays, and/or any other context where virtual content is intended to appear spatially registered relative to a real environment. In further variations, one or more stack layers can be curved along one axis or two axes. Content can be pre-warped, post-calibrated, and/or otherwise corrected for the curved geometry. The device can also be positioned horizontally or at an intermediate tilt to function as a holographic table, gaming surface, map surface, control console, and/or any other suitable tabletop or angled product.

The system can be configured for one viewer, a group of viewers, a passing audience, a camera, and/or a combination thereof. The system can be used in homes, offices, retail environments, public venues, museums, vehicles, mobile products, kiosks, conferences, phone booths, huddle rooms, mirrors, display covers, display cases, signage, and/or any other suitable setting. The system can be used when strong presence and depth are desired in a thin form factor, when conventional two-dimensional readability is intermittently desired, when content is intended to be seen in person and/or in recorded or streamed video, when low compute relative to fully dynamic light field rendering is desired, when an existing two-dimensional display is to be upgraded with a static light field module, and/or under any other suitable operating condition.

In variations, a hybrid module can be integrated into a phone, tablet, foldable device, case, peripheral, display cover, and/or any other portable platform. In some variations, a user-removable cover carrying a static light field image generator can be adhered to or placed over an existing display to create a lightweight holographic effect without permanently modifying the device. In still further variations, the system can be implemented as a large-format tiled installation, including tiled light field print and lens elements overlaid onto a larger display element such as a microLED wall, and/or as a projector-based installation in which mapped two-dimensional content is projected onto a rear surface of the optical stack or a surface behind the optical stack. In further variations, the system can be implemented as a tiled and/or modular product in which smaller static light field image generator subassemblies are bonded behind a larger lens sheet, integrated into repeated modules, and/or assembled into a wall-scale product. Seams can be managed using dark matrices, feathered transitions, repeat-period control, seam overlays, index-matched seam bonding, and/or calibration tables. In related variations, one or more modules can be user-removable and/or service-replaceable.

However, the system can be otherwise configured.

### 3.1 Static Light Field Image Generator

The static light field image generator 100 functions to generate at least part of a perceived three-dimensional scene by physically embodying light field information in one or more media layers and optically directing different portions of that light field information toward different viewing directions. In preferred variations, the static light field image generator can encode a plurality of two-dimensional views corresponding to different perspectives of a three-dimensional scene, a plurality of ray samples of the three-dimensional scene, and/or any other suitable light field representation, such that one viewer at different viewing positions, multiple viewers at different viewing positions, and/or a moving camera can perceive different view-dependent imagery and thereby perceive depth. The static light field image generator can generate a three-dimensional background, foreground, enclosure, alcove, stage, product volume, floating image, and/or any other suitable apparent spatial environment, and can do so in a standalone print product, in a hybrid display stack with a two-dimensional display, in a switchable two-dimensional/three-dimensional display, in a reflective or heads-up configuration, and/or in any other suitable implementation.

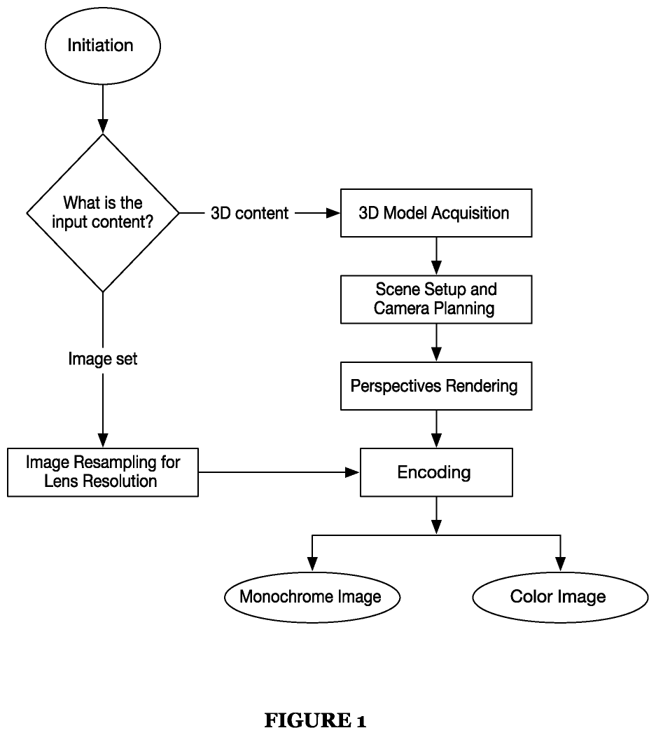

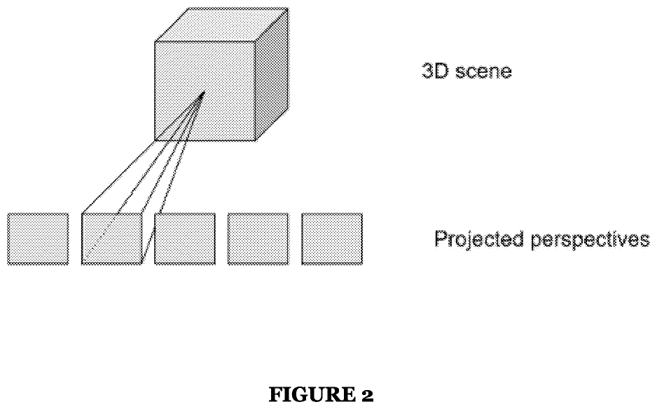

The static light field image generator 100 content can be authored from any suitable scene representation including photographs, video, depth maps, meshes, CAD models, point clouds, radiance fields, NeRFs, Gaussian splat, signed-distance fields, game-engine scenes, synthetic renderings, captured scenes, and/or any other suitable sources. A content-authoring system can generate multiple perspectives of a target scene, generate one or more ray-based encodings, generate one or more depth-aware modifications, and produce one or more physically realizable encoded layers (example shown in FIG. 1). In perspective-based variations, the system can place virtual cameras at multiple viewpoints across one axis or two axes, render corresponding perspectives (example shown in FIG. 2), and interlace those perspectives into one or more encoded media layers. In ray-based variations, the system can directly encode samples of a light field having two spatial dimensions and two angular dimensions and/or corresponding ray distribution into the media layers. In either case, the encoded layers can be generated to cooperate with a specific optical steering structure so that different rays and/or views are directed toward different viewing directions. The content-authoring system can be operated by a manufacturer, an artist, a content studio, a product integrator, a retailer, a user, and/or any other suitable actor. The encoding computation can be performed during initial authoring, during manufacturing, during calibration, during remastering for a replacement cartridge, during scaling for a different lens pitch, during compensation for curvature or reflection, and/or at any other suitable time.

In preferred variations, the static light field image generator 100 can be fabricated and assembled using controlled alignment, controlled lamination, controlled spacing, calibration, and/or any other suitable fabrication workflow.

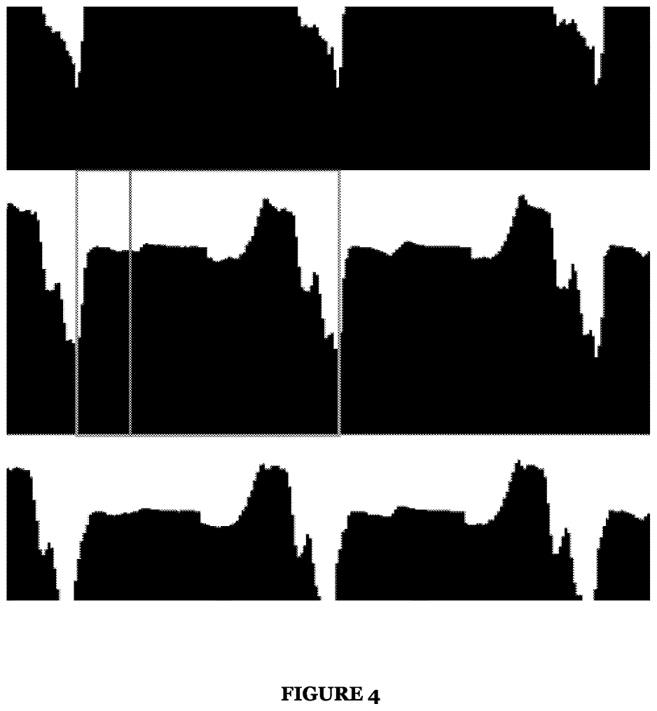

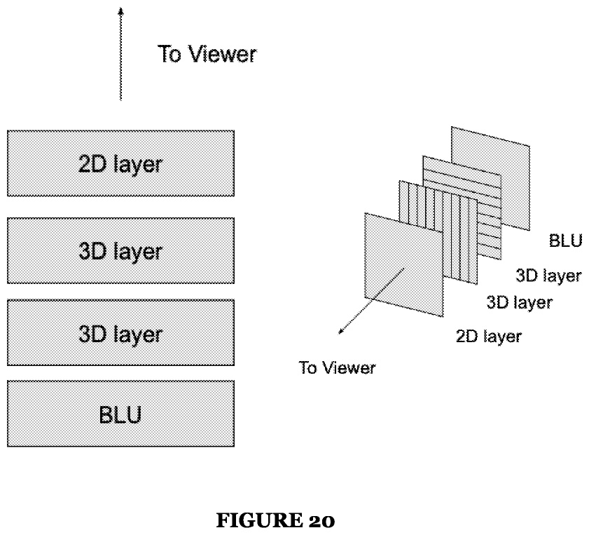

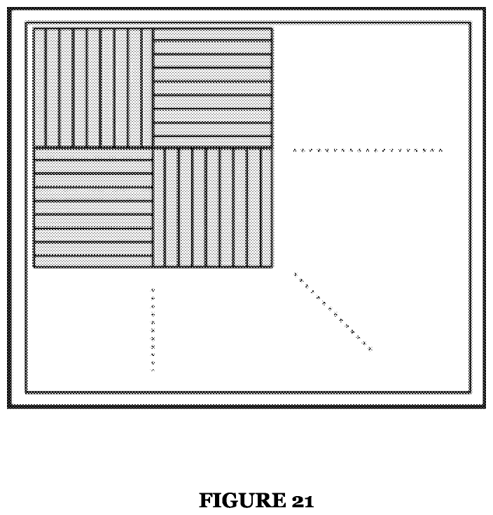

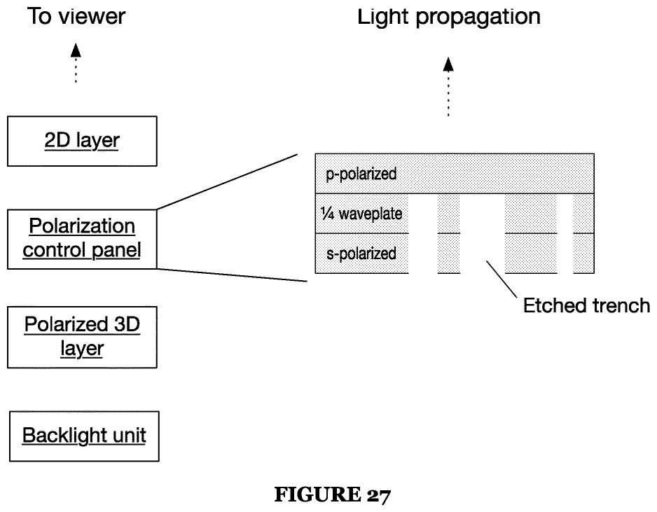

The static light field image generator can include one or more encoded media layers and one or more optical steering structures. In some variants, the encoded media layer(s) and optical steering structure(s) can be the same and/or integrated together (e.g., to form a hologram, integrated diffraction etchings, etc.). However, the encoded media and optical steering structures can be separate. The encoded media layers can function to store, embody, attenuate, emit, filter, and/or otherwise represent the light field information corresponding to the three-dimensional scene. The encoded media layers can include one or more monochrome layers, one or more color layers, one or more stimulus-responsive layers, one or more emissive layers, one or more etched layers (example shown in FIG. 27), one or more embossed layers, one or more holographic layers, one or more diffractive layers, one or more film-exposed layers, one or more auxiliary angular-filter layers, and/or any other suitable layers. In preferred print-based examples, a first monochrome layer can host grayscale light field information at a relatively high view count and/or ray count, optionally using very high-resolution printing, or other suitable patterning methods mentioned herein, and/or anisotropic pixel encoding, while a second color layer can host color information at the same or a lower view count and/or ray count (example shown in FIGS. 4, 6, 7 and 8). In such examples, the color layer can be laminated to, printed onto, registered with, and/or otherwise optically associated with the monochrome layer. The optical steering structure (e.g., parallax generator) can function to direct different encoded views, rays, and/or angular components into different view regions to reconstruct a multi-view three-dimensional scene. The optical steering structure can include a lenticular array, a fly-eye array, a microlens array, a lenslet lattice, a parallax barrier, a diffractive array, a holographic optical structure, an etched redirection structure, and/or any other suitable structure. Although lenticular lenses are preferred in many horizontally parallaxed variations (example shown in FIG. 20), the optical steering structure can additionally or alternatively include a fly-eye lens array, microlens array, elliptical lens array, grid-based lens array (example shown in FIG. 21), parallax barrier, diffractive lattice, holographic optical element, etched redirection structure, and/or any other suitable structure. Full-parallax variations can use a two-dimensional lens lattice or equivalent two-dimensional angular steering arrangement. In such cases, anisotropic encoding can be adapted in aspect ratio and packing to the intended horizontal and vertical angular extents. The optical steering structure can be homogeneous across the device or heterogeneous across patches. For example, some patches can provide horizontal parallax, some patches can provide vertical parallax, some patches can provide narrower view cones, and some patches can provide deeper volume or better two-dimensional resolution. In preferred fabrication variations, one or more encoded media layers, optical steering structures, and/or associated auxiliary layers can include alignment marks such as lines, crosses, polygons, machine-vision fiducials, and/or other patterns. Such marks can be used by human operators, camera systems, computer-vision systems, and/or robotic placement tools to align the monochrome layer, color layer, optical steering structure, auxiliary angular-filter layers, encapsulation structures, lighting structures, and/or other stack elements. Lamination and bonding can use OCA, LOCA, UV-curable adhesives, index-matched adhesives, gels, spacer lands, shims, and/or other suitable approaches. Controlled Z-gaps can preserve focus, reduce Newton rings, reduce alias-prone orders, accommodate auxiliary layers, simplify alignment, and/or otherwise improve manufacturability.

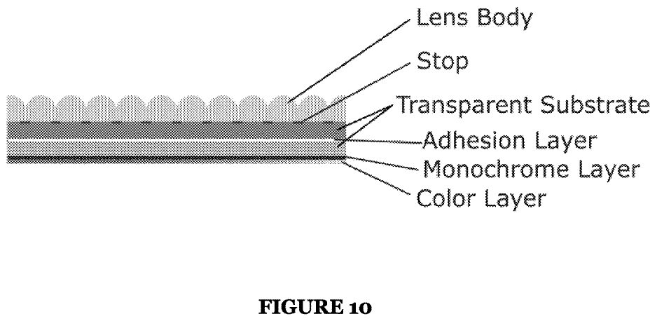

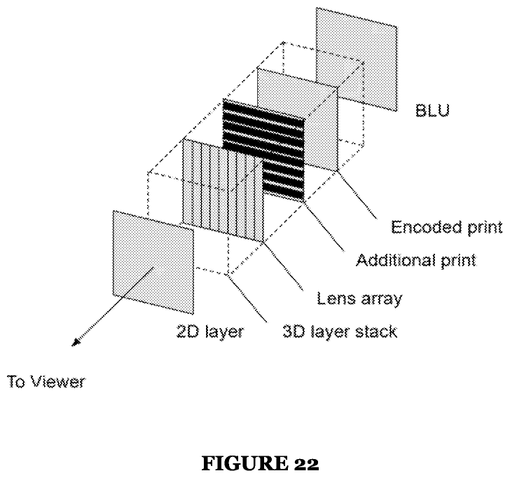

One or more auxiliary layers can be added to modify angular behavior without themselves carrying primary scene content. For example, an auxiliary layer can function as a parallax barrier to introduce a complementary parallax component, thereby enabling or improving full-parallax behavior when used with a base layer that otherwise provides predominantly one-dimensional parallax (example shown in FIG. 22). As another example, shown in FIG. 10, an auxiliary layer can function as a periodic aperture stop aligned to the lens lattice so as to narrow a view cone, improve depth sharpness, suppress off-axis lobes, improve privacy, and/or reduce crosstalk. The auxiliary layer can be printed on the lens substrate, printed on a separate film, laminated with controlled spacing, formed as a black matrix, formed as an absorptive or reflective mask, made anisotropic, and/or made programmable using a thin-film spatial light modulator, liquid crystal panel, electrochromic array, polymer-dispersed liquid crystal (PDLC) array, MEMS micro-blind, DMD, and/or any other suitable controllable structure. Multiple auxiliary layers can coexist with one another and with one or more encoded light field layers. For all such auxiliary-layer variations, the print surface of the auxiliary layer is preferably non-coplanar with the encoded light field layer so that the intended angular filtering is preserved. A controlled Z-gap, for example maintained by index-controlled adhesive and/or shim lands, can mitigate Newton rings, preserve focus onto the encoded layer, and/or simplify alignment. The auxiliary layer can be registered via fiducials and can optionally include slight pattern pre-warp to account for lens distortion. In some variants, an auxiliary layer can include a flip controller and/or privacy barrier such as described in U.S. Pat. No. 11,415,728 titled ‘SYSTEM AND METHOD FOR HOLOGRPAPHIC DISPLAYS’ issued on 16, Aug. 2022 which is incorporated in its entirety by this reference. The auxiliary layer can exist behind or in front of the lens lattice.

In preferred variations, the static light field image generator 100 includes a high-resolution monochrome layer. The monochrome layer can encode luminance, grayscale, opacity, and/or angular structure at significantly higher spatial resolution than a conventional color print. In preferred variations, the monochrome layer can be printed or exposed using a laser photoplotter, film writer, mask writer, direct-laser writer, and/or any other high-resolution device that are usually constrained to being monochromatic. The monochrome layer can be one-bit, few-bit, halftoned, grayscale, exposure-density-based, transmissive-density-based, reflective-density-based, and/or otherwise represented.

In preferred variations, the high-resolution monochrome layer can be printed or otherwise produced at spatial resolutions ranging from approximately 5,000 PPI to 50,800 PPI or greater, with minimum addressable feature sizes on the order of 2 to 10 microns or smaller. For reference, commercially available color printers typically produce the equivalent of approximately 200 to 300 LPI, representing a resolution differential of one to two orders of magnitude relative to the monochrome layer. This large resolution differential enables the monochrome layer to accommodate a significantly higher view count than its color counterpart, sufficient to achieve three-dimensional reconstruction with perceived depth that can rival interference-pattern holograms, whereas a color-only print at conventional resolution typically achieves a lower perceived depths due to crosstalk, limited view cone, and poor angular resolution.

In one example (where substantially isotropic pixels are used, for instance when a full pull parallax device is made using a lens array or other suitable optical elements), the effective grayscale PPI of a high-resolution monochrome printer can be estimated as the native DPI divided by the number of dots allocated to represent a gray level; for example, a printer operating at 50,800 DPI using a 16×16 dot halftone cell for 256 gray levels yields an effective grayscale PPI of approximately 3,175, which remains higher than commercially available color printers and is thus able to increase the achievable 3D depth than not using the monochromatic layer.

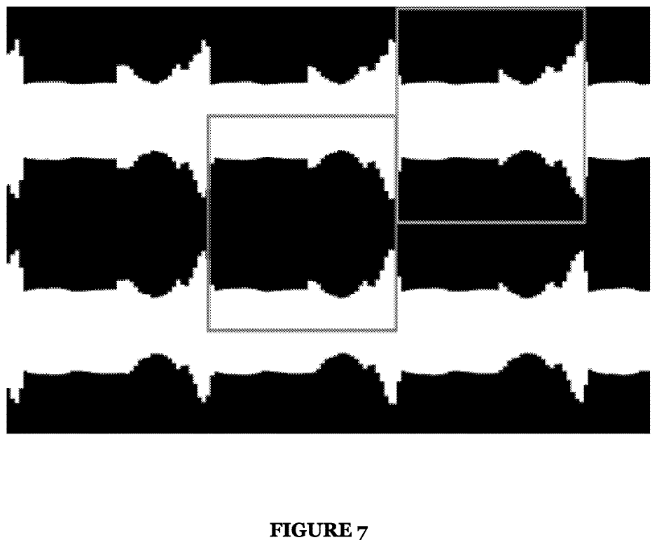

In a preferred set of variations, the monochrome layer uses anisotropic pixels. In such variations, one dimension of the encoded region for a pixel is used predominantly for angular separation and another dimension is used predominantly for grayscale and/or spatial information. However, the dimensions can encode other suitable information. For example, under a lenticular lens providing horizontal parallax, a narrow width can be used to separate adjacent perspectives while an elongated vertical extent can be used to encode grayscale by varying the size, height, density, position, area coverage, and/or distribution of a darkened region (example shown in FIG. 7). The anisotropic pixel can be implemented as a continuous pillar, a center-anchored region, an end-anchored region, a dashed region, a sectioned region, a randomized region, and/or any other suitable intrapixel pattern. The total darkened area can correspond to a desired grayscale level while the angular placement of the anisotropic pixel under the optical structure can correspond to a desired view direction. This arrangement can increase the number of available views under a lens relative to a conventional square-pixel encoding and can therefore support much deeper and smoother three-dimensional reconstructions. FIG. 4 shows an example of the anisotropic pixel implementation where the red line represents the area allocated for a pixel for a view direction and the green box represents the collection of pixels at the same spatial location for all view directions. In some variations, the anisotropic pixel geometry can be modified to trade off grayscale depth, vertical spatial resolution, angular resolution, crosstalk, manufacturability, moiré pattern cancellation, alignment tolerance, and/or other characteristics of the display or layers thereof. The fabrication process for the monochrome layer can be selected based on target size, cost, angular resolution, optical efficiency, lifetime, switching needs, environmental durability, and/or any other suitable requirement. In preferred variations, alignment marks and/or machine-vision-readable fiducials can additionally be used to verify registration of the monochrome layer relative to the optical steering structure and/or other stack layers during manufacturing and quality control

The static light field image generator 100 can additionally include a color layer. The color layer can be positioned behind, in front of, on, within, laminated to, printed directly onto, and/or otherwise integrated with the monochrome layer. The color layer can provide chrominance information at the same view count as the monochrome layer, at a lower view count than the monochrome layer, at a different pitch than the monochrome layer, at a different per-view spatial resolution than the monochrome layer, and/or in any other suitable relationship. In preferred variations, the color layer can be lower resolution than the monochrome layer because commercially available color printing is typically lower resolution. Nevertheless, the combined system can produce a convincing full-color three-dimensional result because fine structural detail and depth cues can be carried by the monochrome layer while chrominance information can be supplied more coarsely by the color layer. The color layer can therefore function analogously to a lower-frequency chrominance contribution over a higher-frequency luminance contribution. The color layer can be implemented as an interlaced multiview color print, a depth-aware softened or blurred multiview color print, a color strip arrangement, a diffuse color wash, a selectively desaturated and/or selectively transparent chrominance layer, and/or any other suitable arrangement. When the color layer is implemented using CMYK printing, the K channel can be omitted, reduced, remapped, and/or otherwise adjusted in cases where the monochrome layer already substantially provides the grayscale contribution. The difference in resolution in the monochrome layer and color layer is analogous to the YUV420 color format used in digital video compression, in which the luminance (Y) channel is sampled at full spatial resolution while the chrominance (U and V) channels are sampled at reduced resolution. In that format, the perceptual quality of the resulting image remains high despite chrominance subsampling because the human visual system has substantially lower spatial acuity for color differences than for luminance differences. The same physiological principle applies here: the monochrome layer provides high-spatial-frequency luminance and angular detail to which the eye is sensitive, while the color layer provides lower-spatial-frequency chrominance information to which the eye is comparatively less sensitive, yielding a combined result that appears to the viewer as a full-color, high-resolution, high-depth three-dimensional image.

In some variations, the color layer is preprocessed using scene depth, disparity, localized inter-view disparity, expected crosstalk, predicted print artifacts, printer-specific characteristics, and/or other criteria. For example, color information associated with features far from a zero-parallax plane can be softened, blurred, faded, decolorized, contrast-reduced, and/or otherwise modified to reduce objectionable crosstalk when printed at lower spatial density. Similarly, localized color contrast in the encoded color image can be reduced where print limitations would otherwise produce visible beating or cross-contamination across views. Such processing can be performed before interlacing, after interlacing, during interlacing, during printer-specific optimization, during cartridge remastering, and/or at any other suitable stage.

The static light field image generator can be transmissive, reflective, transflective, partially transmissive, partially reflective, emissive, subtractive, additive, fluorescent, phosphorescent, and/or any suitable combination. For example, the static light field image generator can be constructed so that ambient light and/or system-provided illumination passes through printed or otherwise encoded regions to produce a transmissive three-dimensional scene, can be illuminated and viewed in reflection, can include partially transparent or unprinted regions that create floating and/or see-through effects, and/or can be combined with index-matched regions, partial lens regions, or dashed lens regions to selectively increase transparency in localized areas. The generator can provide horizontal parallax, vertical parallax, full parallax, plane-constrained simulated full parallax, patch-wise parallax, directionally heterogeneous parallax, and/or any other suitable parallax arrangement. In some variations, multiple static light field image generating layers can be stacked, crossed, patched, and/or otherwise combined within a single optical stack, such that different regions or layers provide different parallax directions, view cones, depth characteristics, angular filtering characteristics, and/or other optical properties. In some variations, the static light field image generator can be configured so that encoded three-dimensional content extends not only behind the physical front surface of the device but also apparently in front of that surface, creating a volumetric effect in which objects, logos, characters, or other three-dimensional elements appear to float outward toward or past the viewer. This can be achieved by placing selected scene elements at positive disparity values with respect to a zero-parallax plane and by selecting angular sampling, view cone, and lens parameters that support reconstruction of content at such apparent positions without undue crosstalk or breakup. In hybrid display configurations, two-dimensional image content displayed on an active layer can be composited with awareness of three-dimensional elements encoded to appear in front of the display surface, such that the two-dimensional content is occluded by, or appears to pass behind, such foreground three-dimensional elements. For example, a character moving across the display can disappear behind a three-dimensional foreground element encoded to appear floating in front of the device. This compositing logic can be implemented in a content pipeline during authoring and/or performed in real time by a controller using depth and occlusion information derived from the static light field scene geometry.

In variations, the static light field image generator can cover all or only part of the area of the two-dimensional display layer. Partial-area implementations can create a window-in-window holographic effect while preserving ordinary two-dimensional display functionality elsewhere. In related variations, the combined device can be integrated behind a partially reflective mirror so that the product appears to be a mirror when inactive or dim, and a hybrid light field display when active.

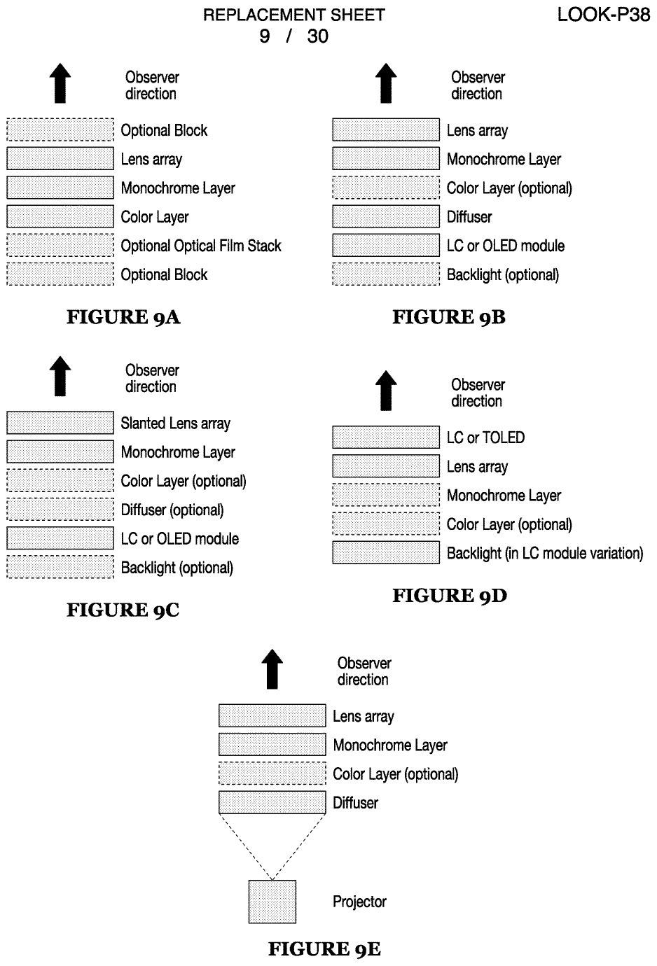

The static light field image generator 100 can additionally or alternatively be realized through structures other than printed layers. In some variations, microfeatures are etched, engraved, embossed, milled, laser-ablated, chemically formed, stamped, replicated, selectively deposited, and/or otherwise formed in or on glass, acrylic, polymer films, backlight plates, and/or other reflective, transparent, transflective, or translucent media. Depending on the implementation, when used alone or in combination of an optical element, these structures can redirect light into prescribed view-dependent distributions and can therefore embody a static light field scene. In some etched-backlight variations, a backlight guide itself can be patterned such that total internal reflection is locally frustrated in a prescribed angular distribution. In still further variations, a film is exposed through a lens array after lamination so that the final light field structure is auto-registered by construction. In one preferred manufacturing variation, a photosensitive layer is first laminated to a lens array using a controlled spacing and then exposed through the lens array using multi-view projected images, optical holographic methods, computer-generated holographic methods, and/or any other suitable exposure source. Because the exposure occurs through the final optical steering structure, registration can be achieved inherently or at least greatly simplified. This can be especially valuable for large areas, for reducing alignment burden, and/or for accommodating wavelength-specific compensation during mastering. Examples of lens array combinations are given in FIG. 9A-E.

In variants, the static light field image generator 100 can include stimulus-responsive materials and/or emissive layers. For example, the layer can darken, brighten, emit, change color, become more or less opaque, and/or otherwise change in response to infrared illumination, ultraviolet illumination, visible illumination, heat, electric fields, magnetic fields, voltage difference, chemical stimuli, and/or other energy inputs. A phosphor-containing layer, quantum-dot layer, fluorescent layer, and/or other optically excitable medium can be used not only to display a scene but also to compensate for attenuation and/or to wash out contrast for two-dimensional mode operation.

The static light field image generator 100 can be made partially transparent or translucent by leaving clear regions, using reduced fill factors, using partial or dashed lens arrays, index-matching selected lens regions, and/or otherwise permitting ambient light to pass through the optical structure. The generator can additionally or alternatively be encapsulated within or against a higher-index body such as acrylic, glass, resin, and/or other transparent media. Such encapsulation can move an apparent image plane, change apparent spatial placement, protect the media, and provide physical reference features such as edges, ridges, engravings, molded structures, and/or printed references that reinforce a floating volumetric perception. In further variations, anti-reflection coatings, moth-eye textures, matte outer surfaces, low-haze films, and/or index-matched internal interfaces can be used to reduce glare and ghosts. Where polarization recycling is present, isotropic substrates can be preferred, layer ordering can be selected to reduce exposure of the static light field image generator to polarized light prior to panel polarizers, and/or emissive display layers can be used to reduce polarization-driven non-uniformities and color shifts.

However, the static light field image generator can be otherwise suitably configured.

### 3.2 Two-Dimensional Image Generator

The two-dimensional image generator 200 functions to generate two-dimensional image content. The two-dimensional image content can be optically combined with the static light field image generator such that the two-dimensional image content appears spatially coordinated with, embedded within, behind, in front of, and/or otherwise integrated with the three-dimensional scene generated by the static light field image generator.

In transmissive stack variations, the two-dimensional image generator can be an open-cell LCD or other transmissive panel that modulates light passing from a backlight and/or other illumination source through the static light field image generator and toward a viewer. In emissive variations, the two-dimensional image generator can be an OLED, transparent OLED, microLED, miniLED, emissive projection surface, and/or other emissive panel. In projector variations, the two-dimensional image generator can project onto a diffuser, scattering layer, a rear surface of a light field subassembly, and/or any other suitable target.

In some variations, the two-dimensional image generator can be positioned behind the static light field image generator to prioritize three-dimensional depth and/or integration with the static light field scene, while in other variations the two-dimensional image generator can be positioned nearest a viewer so as to maximize apparent two-dimensional resolution by avoiding transmission of the two-dimensional image content through refractive and/or diffusive, or otherwise view direction selective structures (e.g., parallax barriers). In further variations, the two-dimensional image generator can be transparent or partially transparent, thereby allowing ambient scenery, a physical product, and/or portions of the light field scene to remain visible through the optical stack. In selecting and arranging the two-dimensional image generator, the system can additionally account for display-pixel pitch, lens pitch, print pitch, subpixel structure, diffusion, haze, stack separation, and/or other optical-stack parameters to mitigate aliasing, moiré, and/or other visually objectionable interactions between the active display element and the static light field image generator. In further variations, the pitch, tilt, orientation, and spacing of the optical steering structure, encoded rows design, display-pixel mosaic, touch grid, brightness-enhancement films, and/or extraction structures can be selected to reduce visible low-frequency beats. Small tilts, artificial pitch offsets, anisotropic diffusion, micro-pitch jitter, modest defocus, and/or other pitch-decorrelating approaches can be used. In preferred implementations, the tilt angle of the optical steering structure relative to the display pixel mosaic is constrained within approximately ±15 degrees of a primary axis to limit tilt-related artifacts (e.g., swim artifacts, skew artifacts, etc.). A swim artifact is one in which the perceived three-dimensional scene appears to shift laterally as a whole when the viewer moves vertically relative to the display. A skew artifact can arise when a viewer at a finite viewing distance experiences a differential horizontal parallax shift when looking at different vertical positions on the display, resulting in the perceived three-dimensional geometry appearing sheared or skewed, for example causing a rectangular back wall of an alcove to appear as a parallelogram. While some degree of the skew effect can be compensated in software for a single viewing distance, it cannot be fully corrected for all viewing distances simultaneously. Accordingly, a preferred practical range of lenticular tilt is constrained to reduce these artifacts over an intended viewing-distance range for the application. By contrast, the tilt of the encoded light field print layer relative to the display array can be adjusted more freely and independently of the lenticular tilt, since print rotation primarily affects aliasing interaction between the baseline of the anisotropic print rows and the display pixel rows, which is generally more tractable to manage through print-parameter adjustment. Two distinct categories of aliasing interaction can arise in optical stacks combining a periodic lens array, a high-resolution print layer, and an active display element. A first category arises from interaction between the periodic direction of the lens array and the subpixel mosaic of the display panel, which can produce visible colored or black-and-white fringes and can be managed by selecting lens pitch, rotation, and separation relative to the display subpixel array to place the resulting beat frequency outside of a perceptible spatial frequency and contrast for an intended viewing distance range. A second category arises from interaction between the baseline of the encoded print rows and the pixel-row spacing of the display panel. This second interaction can be managed through adjustment of the print-row pitch and/or a small artificial row tilt. In preferred implementations, the tilt and pitch of the lens array and the tilt and pitch of the print-row baseline are controlled independently and in combination to mitigate both aliasing interactions simultaneously, with the two rotational degrees of freedom treated as separable design parameters.

The two-dimensional image generator can provide any suitable content including people, products, UI elements, conversational agents, text, menus, subtitles, particles, flames, shadows, reflections, lighting effects, synthetic renderings, live video, recorded video, and/or any other suitable content. In variations, the two-dimensional image generator can provide full-screen content, partial-screen content, keyed content, masked content, segmented content, alpha-matted content, content with removed background, content over a white or otherwise selected background, and/or content aligned with transparent, translucent, unprinted, and/or partially attenuating regions of the static light field image generator. Partial-area implementations can create a window-in-window holographic effect while preserving ordinary two-dimensional display functionality elsewhere. In related variations, the combined device can be integrated behind a partially reflective mirror so that the product appears to be a mirror when inactive or dim, and a hybrid light field display when active. In preferred hybrid-display examples, the two-dimensional image content can be geometrically mapped, shadow-mapped, reflection-mapped, brightness-adjusted, depth-aware, partially occluded, and/or otherwise coordinated with the static light field scene such that a displayed person, object, or interface element appears seated within the three-dimensional environment, appears to pass behind or in front of portions of the three-dimensional environment, and/or otherwise participates in a coherent composite spatial illusion. By way of example, the two-dimensional image generator can display a live actor, recorded person, animated character, synthetic product, or conversational agent embodiment apparently located within a light field alcove, world, stage, volume, and/or enclosure, and can further provide mapped shadows, highlights, reflections, and/or masking effects that visually connect the two-dimensional content to the three-dimensional scene. The two-dimensional image generator 200 can additionally be used in reflected and heads-up-display variations. In such variations, the dynamic content can be pre-warped and/or inverted so that after reflection by a reflective combiner, mirror, and/or heads-up-display optic, the content appears correctly oriented and at a desired virtual distance relative to a real environment.

The two-dimensional image generator can be used continuously, intermittently, in response to sensing, in response to content metadata, in response to time schedules, and/or in any other suitable manner. In variations, operation of the two-dimensional image generator can be coordinated with a controller, illumination system, and/or switching system so that the two-dimensional image generator participates in a three-dimensional mode, a two-dimensional mode, and/or one or more intermediate modes. For example, the two-dimensional image generator can provide dynamic subjects and/or overlays while the static light field image generator remains perceptible in a three-dimensional mode; can provide conventional two-dimensional video, text, user-interface content, presentations, and/or advertisements while the static light field image generator is reduced, washed out, bypassed, and/or obscured in a two-dimensional mode; and/or can provide compensation content such as peripheral masking, brightness-equalization content, washout-compensation content, and/or other mode-supporting image content. In some variations, the two-dimensional image generator can additionally provide at least part of the apparent color of the composite scene, including colorization of a nominally monochrome or luma-dominant static light field scene. In further variations, the two-dimensional image generator can be integrated into a standalone system, combined with a removable or swappable static light field module, retrofitted to an existing display, tiled across a large-format installation, and/or implemented in a projector-based architecture for reduced installation weight and/or portable deployment.

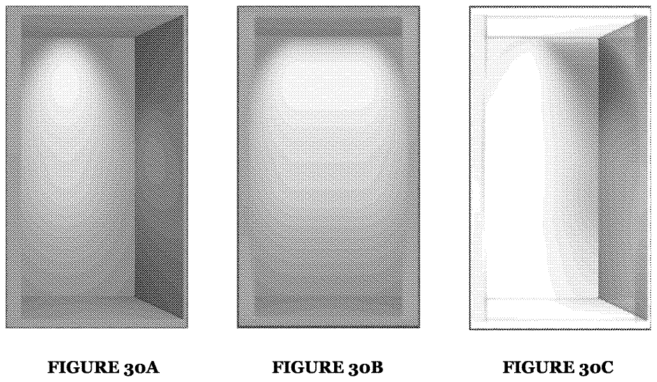

In some variations, a portion of a view-invariant shade associated with the static light field scene can be computationally separated from the three-dimensional layer and relocated to the two-dimensional image generator. In a variant, the two-dimensional image generator can provide a complementary image hosting part of the information from the 3D scene such that the said proportion of the image is moved from the static 3D layer to the updateable 2D layer. For instance, view-invariant parts of the 3D content can be moved to the 2D layer to reduce the amount of non-updatable content/area in the 3D layer. As another example, the view-invariant part of the shade of the 3D content can be moved to the 2D layer, such that the same desired 3D scene is reconstructed when the 2D and 3D layer is combined, while the shade built into the 3D layer is reduced (example shown in FIG. 30).

For example, where a given location of the three-dimensional scene exhibits a range of darkness values across different view directions, a view-invariant component of that darkness can be removed from the static light field encoding and instead displayed by the two-dimensional image generator at a corresponding location, such that the combined output of the two-dimensional image generator and the static light field image generator reproduces the intended target view. In this manner, the two-dimensional image generator can host not only dynamic content and color information, but also a shade component that would otherwise be built into the static three-dimensional layer. Hosting the shading component in the two-dimensional content can reduce adverse effects on two-dimensional image representation when the three-dimensional layer is not supposed to be visible, for example due to occlusion by the two-dimensional content or in cases where the three-dimensional scene is not needed. In preferred variations, the relocated view-invariant shade can be blurred before being removed from the three-dimensional layer. In these variations, a lightening-only blur can be preferred so that slight misalignment between the two-dimensional layer and the static light field layer is less noticeable without causing the two-dimensional layer to overshade the reconstructed view.

In further variations, a relocation of view-invariant shade from the static light field image generator to the two-dimensional image generator can be used in combination with a switchable diffuser, a retractable diffuser, and/or other three-dimensional nullification approaches. For example, where a PDLC layer or retractable diffuser distorts the directionality of rays from the three-dimensional layer, residual shade in the static three-dimensional scene can contribute to uneven backlighting or reduced apparent brightness in a two-dimensional mode. By reducing the shade that is built into the usually static three-dimensional layer and instead providing at least part of that shade through the updatable two-dimensional image generator, the system can achieve a brighter and more artifact-free two-dimensional presentation when the three-dimensional scene is not desired. This can be used in combination with brightness-equalization masks, complementary compensation images, local backlight control, and/or other two-dimensional-mode compensation techniques.

Furthermore (e.g., in a switchable system), the 2D layer can also host an image to compensate for the residual adverse in different modes. For instance, residual traces of the 3D scene can present even when a switchable diffusive layer is used to nullify the 3D scene. The 2D layer can host an inverse of the said residual images for a more complete removal of the 3D scene. In a preferred variant, the partial content and shade migration to the 2D layer, the compensation imagery, or the combination of them can be implemented into the content of the corresponding modes to make the device brighter, more energy efficient, more updatable, or bringing other effects while bringing little to no adverse effect on the intended content.

As a simplified example of using the 2D screen to apply shade, when a certain location of the 3D scene has a shade ranging from 50% to 100% black (for different view directions), a 50% shade can be moved to the 2D layer at the corresponding location such that the 3D layer now hosts a range from 0% to 100% shade instead to represent the same 3D scene when combined with the 2D layer. A second example is shown in FIG. 30A through FIG. 30C, where FIG. 30A shows a target view (for a certain view direction); FIG. 30B shows the blurred view-invariant shade that is moved from the 3D layer to the 2D layer; and FIG. 30C shows the corresponding modified view.

In variants, the two-dimensional image generator 200 can present live-video subjects that have been segmented from their background, such that a live person, agent, and/or other dynamic subject can be inserted into the static light field scene for telepresence, virtual assistance, education, conferencing, retail engagement, and/or other interactive use cases. In such variations, the displayed subject can further interface with the light field-projected three-dimensional environment using masking effects, mapped shadows, mapped reflections, and/or other compositing effects. In further variants, the two-dimensional image generator 200 can be implemented in projector-based architectures, including short-throw and ultra-short-throw projector architectures, in which mapped two-dimensional content is projected onto a rear surface and/or diffuser associated with the optical stack. In such variations, the print, lens, and diffusing-layer subassembly can be made relatively light and can in some cases be rolled for transport and later unrolled for installation, such as at tradeshows or temporary installations.

However, the two-dimensional image generator can be otherwise configured.

### 3.3 Illumination Module

The illumination module 300 functions to provide light into, through, onto, and/or around the optical stack. Providing light acts to render the static light field image generator perceptible, support presentation of two-dimensional content by the two-dimensional image generator, enable switching and/or nullification modes, and/or to visually bind dynamic two-dimensional content to a static three-dimensional scene.

The illumination module 300 can include a rear backlight, an edge-lit plate, front illumination, side illumination, one or more local light sources, one or more ambient light couplers, stimulation illumination sources, ultraviolet sources, visible sources, infrared sources, and/or any other suitable illumination components. In transmissive stack variations, the illumination module 300 can include a rear backlight unit configured to illuminate the static light field image generator through a transmissive two-dimensional display layer and/or through other transmissive portions of the optical stack. In emissive-stack variations, the illumination system 300 can omit a conventional rear backlight and can instead include controlled front illumination, edge illumination, local illumination, and/or other suitable directed illumination. In some variations, the illumination module 300 can additionally include one or more light-guide plates, diffusers, brightness-enhancement films, polarization-recycling films, angular-conditioning films, reflective films, scattering films, and/or other optical films selected to shape intensity, directionality, uniformity, efficiency, polarization state, and/or spectral content of the illumination. In further variations, the illumination module 300 can be integrated with a backlight plate that itself includes etched, embossed, diffractive, and/or otherwise encoded light field structures, such that the backlight plate participates in generating a prescribed angular light distribution for the three-dimensional scene while maintaining a thin form factor. The illumination system 300 can be spatially uniform, locally dimmable, temporally modulated, polarization-aware and/or modulated, wavelength-selective, and/or otherwise controlled. In some embodiments, the illumination system can include a light guide plate and one or more optical films such as diffusers, prism or gain films, brightness-enhancement films, and/or polarization-recycling films. Where the light distribution exhibits a significant nonuniformity in an axis aligned with a focusing direction of the static light field image generator, visible striping and/or lens-period brightness non-uniformity can result. For example, a 3M brightness enhancement film with a sharp angular brightness distribution falloff can react with a lens array or a lenticular, resulting in the edge of a repeating unit of the optical element being much dimmer than its center, and in turn a visible strip pattern(s). Mitigation can include omitting a brightness-enhancement film, rotating a prism direction so that it is substantially orthogonal to the primary focusing direction, adding a controlled diffuser or angular-mixing film, increasing mixing distance within the stack, and/or using modified gain films whose brightness distribution falloff is reduced or decorrelated relative to the lens'focusing direction. In preferred variations, a diffuser that is weak enough to reduce objectionable aliasing without destroying light field directionality can exist between the three-dimensional layer and the viewer.

In some variations, a rear backlight can illuminate the static light field image generator to create a three-dimensional background. In such variations, the rear backlight can provide a primary illumination state used in a three-dimensional mode, wherein light is directed through or into the static light field image generator so that multiview depth cues are preserved and the static light field scene appears behind, around, and/or in front of dynamic two-dimensional content. In other variations, an edge-lit plate can provide a light source to support a two-dimensional mode. In preferred dual-illumination examples, the rear backlight can be turned off while the edge-lit plate is activated, such that angular cues from the static light field image generator are substantially washed out and the display behaves substantially like a conventional two-dimensional screen. The edge-lit plate can include a planar light guide with localized frustration structures, screened coatings, micro-dot extraction features, micro-prism extraction features, and/or other suitable light-extraction features selected to improve uniformity, reduce residual view lobes, and avoid objectionable color shift and visible features. In further variations, the illumination system 300 can cooperate with a switchable diffuser, polarization-control arrangement, emissive nullification arrangement, repositionable layer, and/or other switching mechanism, and controller-driven electrical control can be synchronized with content changes so that transitions between two-dimensional and three-dimensional operating modes appear substantially instantaneous and without objectionable transients. In still further variations, a stimulation source can excite an emissive nullification layer. Such a stimulation source can include an ultraviolet illumination source, a visible excitation source, electrical stimulation, and/or any other suitable energy source configured to excite a stationary and/or repositionable emissive layer that reduces apparent contrast of the three-dimensional scene in a two-dimensional mode. In additional variations, the illumination system 300 can include front-lighting, edge-lighting, ambient-light-assisted lighting, and/or directed room lighting that is selected or controlled to improve visibility of a reflective or partially transmissive light field stack. The illumination module 300 can further be coordinated with content such that lighting cues on the two-dimensional layer remain visually consistent with illumination in the physical environment. For example, an ambient-light sensor and/or camera can estimate incident direction, spectrum, and intensity of room lighting, and the controller can responsively drive the two-dimensional image generator and/or selected illumination components to present shadows, reflections, highlights, color washes, and/or spotlight effects that are visually consistent with the light field scene and/or the surrounding environment. In some variations, local backlight and/or 2D display control and/or brightness-equalization control can be used to compensate residual spatial non-uniformity, including non-uniformity introduced by diffusers, gain films, focusing elements, polarization-recycling films, and/or other periodic optical structures in the stack.

In some variations, the illumination module 300 includes a light guide plate and one or more optical films such as diffusers, prism or gain films, brightness-enhancement films, and/or polarization-recycling films. Where brightness-enhancement films give a light distribution that exhibits a significant nonuniformity in an axis aligned or partially aligned with an optical focusing element in the static light field image generator 100, the combined system can exhibit periodic non-uniform brightness over each lens period. Mitigation approaches can include omitting a brightness-enhancement film, rotating a prism direction so that it is substantially orthogonal to a primary focusing direction of a lens array, adding a controlled diffuser or angular-mixing film, increasing spacing or mixing distance within the stack, and/or using modified gain films whose spatial periodicity is reduced or decorrelated relative to the lens pitch. In further variations, mode-synchronized brightness matching can be used. For example, where a switchable diffuser such as PDLC reduces transmission efficiency in a two-dimensional mode, the backlight drive and/or other illumination can be increased in synchronization with activation of a scattering state so as to substantially match viewer-perceived brightness between two-dimensional and three-dimensional modes. In further variations, a calibration procedure can measure a per-location brightness map of the display in a two-dimensional mode and apply a compensating correction using the two-dimensional image generator 200 and/or a locally controllable backlight, thereby improving brightness evenness. Manufacturing and field calibration can additionally be used to compensate non-uniformity, nullification mismatch, aging, and/or other residual errors. In such variations, the controller can spatially adjust the two-dimensional image generator, one or more local illumination sources, one or more switching elements, and/or one or more stimulation drives so that a target brightness distribution is achieved. Calibration can determine drive ratios, duty cycles, compensation maps, and/or other correction values for a two-dimensional mode, a three-dimensional mode, and/or one or more intermediate modes.

However, the illumination system can be otherwise configured.

### 3.4 Switching Module

The switching module 400 functions to selectively alter whether, where, when, and/or how strongly the static light field image generator is perceived. The switching module can enable the system to operate in a three-dimensional mode, a two-dimensional mode, and/or one or more intermediate modes. In preferred variations, the switching module can reveal a three-dimensional scene, hide a three-dimensional scene, reduce a three-dimensional scene, wash out a three-dimensional scene, alter the contrast of the 3D scene, cancel or bypass three-dimensional cues, replace one three-dimensional scene with another, localize a three-dimensional reveal to a selected region, and/or otherwise modulate an intensity or contribution of the three-dimensional scene. In this manner, the switching module can allow a single consumer device, sign, kiosk, communication system, mirror, and/or other hybrid display product to behave at one time as a conventional two-dimensional screen and at another time as a multi-view three-dimensional display.

The switching module can include any one or more of: a dual-illumination arrangement; one or more switchable diffusers; a polarization-control panel; a repositionable emissive layer; a retractable three-dimensional layer; a movable layer spacing mechanism; a software-defined masking mode; a dynamic or segmented three-dimensional layer; and/or any other suitable switching mechanism. One example of switchable diffusers include one or more PDLC layers. In some variations that use switchable diffusers, a plurality of switchable diffusers can be included in the display optical stack, where they are separated from one another (e.g., to increase angular mixing, to even out light from the static light field image generator more quickly, etc.).

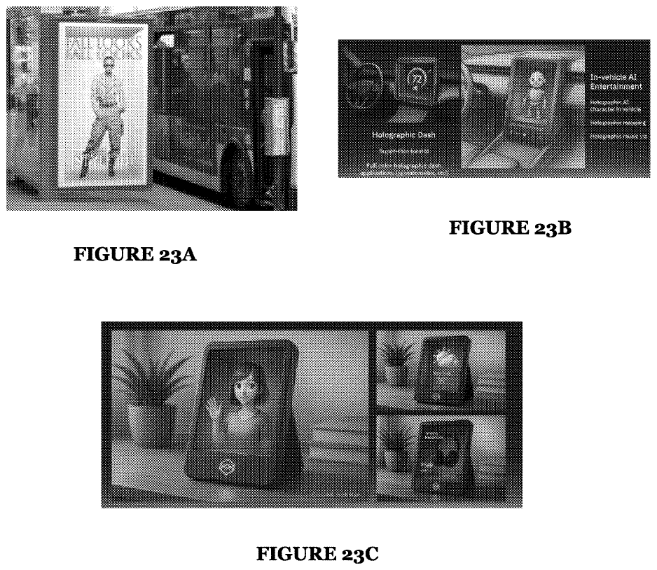

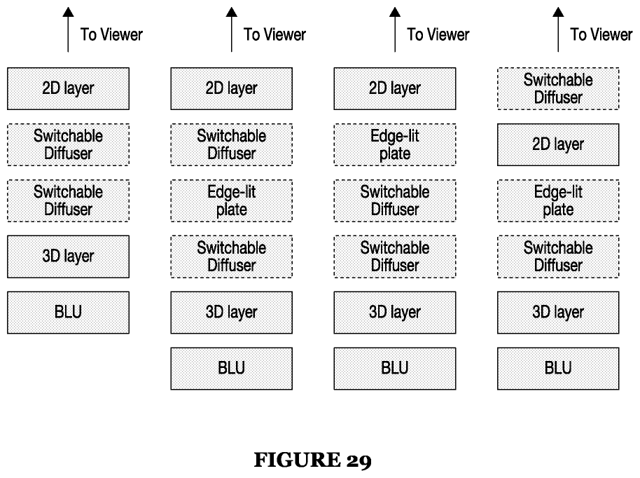

In a first variant, the switching module can include a dual-illumination arrangement, a switchable diffuser, and/or a combination thereof. For example, a rear backlight can illuminate the static light field image generator in a three-dimensional mode so that multiview depth cues remain perceptible, while an edge-lit plate, near-Lambertian source, scattering source, and/or other angular-mixing illumination source can be used in a two-dimensional mode to reduce directional light field cues and cause the display to read substantially as a conventional two-dimensional screen through adjusting the relative brightnesses of the light sources. In related variations, a switchable diffuser such as a PDLC layer can be placed between the two-dimensional image generator and the static light field image generator and can be driven between a lower-haze state that preserves directional light transport for three-dimensional viewing and a higher-haze state that disrupts directional light transport for two-dimensional viewing. In some variations, multiple layers of switchable diffusive layers can be used (for example as shown in FIG. 29). Also, additional light sources such as edge lit plate can also be used optionally to function as a standalone/supplementary light source. In some implementations, the PDLC-based approach can provide a full-surface-area two-dimensional mode while preserving the ability to return to a three-dimensional mode when commanded and can therefore be especially suitable for consumer-device and display applications in which readability and full-screen conventional-media presentation are intermittently desired (example shown in FIG. 23).

In a second variant, the switching module can include one or more contrast-modulation, nullification, and/or mechanical switching arrangements. For example, a polarization-control panel can cooperate with polarization-encoded regions of the three-dimensional scene layer to equalize brightness of scene and background regions and thereby suppress contrast that would otherwise communicate the three-dimensional scene. In another example, a stationary, insertable, repositionable, and/or retractable emissive layer can be energized in a two-dimensional mode to reduce apparent contrast of the static light field image generator, and can be removed, de-energized, and/or repositioned in a three-dimensional mode. In another example, the three-dimensional scene layer itself can be retractable, rollable, belt-mounted, rail-guided, and/or otherwise movable so that the optical path can selectively include a first three-dimensional scene, a number of secondary three-dimensional scene, a blank or transparent region, and/or no three-dimensional scene at all. In still other variations, a movable layer spacing mechanism can alter a spacing between optical layers to modify focus, angular selectivity, and/or perceptibility of the three-dimensional scene. In further variations, the switching system can include a segmented, dynamic, and/or locally addressable three-dimensional layer, such that only selected portions of the display provide three-dimensional cues while other portions remain effectively two-dimensional. For instance, this can be realized using switchable lenses as the optical element. In this way, the switching system can support localized reveals, partial fades, privacy modes, staged transitions, mixed two-dimensional/three-dimensional presentations, and/or any other suitable mode behavior.

In some variants, the switchable diffuser (e.g., PDLC) may physically overlap (and/or underlap or lie beneath) a portion (i.e., not the entirety of) of the 2D display and/or 3D physical encoding. In related variants, the switchable diffuser (e.g., PDLC layer) can have independently addressable regions (e.g., enabling switching behavior in regions or subsets of the display). As one illustrative example, the switchable diffuser can be smaller (e.g., physically, for the portion which is electrically triggered on/off, etc.) than the 2D display area. These variants can, for instance, allow for a small switchable hologram window in a corner of an otherwise 2D laptop display or TV (when holographic window enabled when the PDLC is activated). Potential technical advantages to a switchable diffuser only over a subset of the display area can include cost-savings, reduced complexity (e.g., as only a portion of the display screen is intended to present as a holographic volume when switched into that mode), enable switching on and off of various regions of the light field element, and/or can provide other suitable benefits.

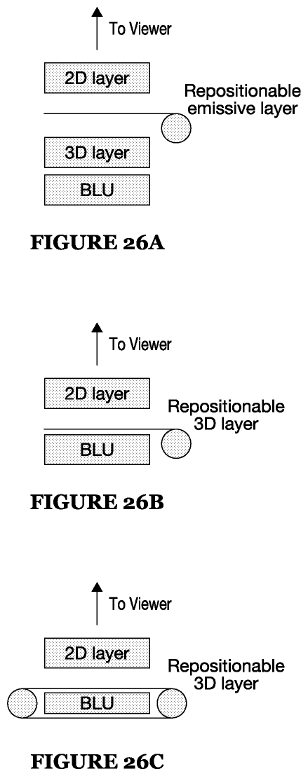

In some variations, the repositionable and/or retractable three-dimensional scene layer can be implemented as a mechanically swappable background or hologram-environment system, for example using rollers, belts, rails, guides, tensioning structures, indexed transport structures, cassettes, and/or other motion systems to move different static light field scene layers into and out of the optical path (example shown in FIG. 26). In such variations, the system can selectively present a first holographic background or environment, a second holographic background or environment, a blank or transparent segment, and/or no three-dimensional scene at all, without requiring that the switching function be limited to two-dimensional versus three-dimensional mode switching. This switchable three-dimensional scene layer can be particularly but not exclusively beneficial in installations such as transportation hubs, public displays, retail environments, museums, and/or other venues where different holographic backgrounds or scene environments are to be swapped over time while preserving a common foreground display architecture. In some implementations, fiducials, encoders, cartridge identifiers, and/or other sensing structures can verify the position and identity of a selected scene layer so that corresponding content, calibration data, and/or operating parameters are loaded automatically.

In a variant, the switching module can include computational and/or controller-coordinated switching. For example, a software-defined masking mode can darken, contrast-suppress, crop, and/or otherwise modify a peripheral and/or selected region of displayed content to obscure fixed three-dimensional environment cues and cause the system to read substantially as a conventional two-dimensional screen, even without an electronically switchable optical layer. In further variations, mode transitions can be initiated in response to user input, remote commands, sensing, proximity, head-pose estimates, ambient-light conditions, time schedules, application state, content-associated identifiers, filename conventions, playlist manifests, embedded metadata, and/or any other suitable triggers. A controller can synchronize switching commands across one or more optical-state elements, including PDLC state, polarization duty cycle, emissive stimulation, retractable-layer position, backlight drive, local brightness compensation, peripheral masking, gamma changes, and/or any other suitable transition-supporting operations, so that transitions between two-dimensional and three-dimensional presentation occur cleanly and without objectionable transients.

In further variants using a switchable diffuser such as PDLC, viewer-perceived brightness in a two-dimensional mode can depend on the angular-integrated light energy reaching a viewer after scattering. If the ray-direction-weighted summation of light for one location is smaller than neighboring locations, that location can appear darker, yielding non-uniform background brightness in the two-dimensional mode. Such non-uniformity can be reduced or eliminated by increasing spacing or mixing distance between the switchable diffuser and the three-dimensional layer, using multiple diffuser layers, predicting or measuring a per-location brightness map in a scattering mode and applying a correction via the two-dimensional image generator 200 and/or local backlight control, and/or authoring the three-dimensional scene encoding so that angular-summed energy is approximately equalized across the display area within a selected tolerance. In further variations, such non-uniformity and/or nullification mismatch can be characterized during manufacturing and/or field recalibration, and corresponding compensation values can be stored for use in a two-dimensional mode, a three-dimensional mode, and/or one or more intermediate modes. Such compensation can include adjustment of one or more switching elements, stimulation drives, local illumination regions, and/or output of the two-dimensional image generator. In a variant, the 2D layer can also host an image to compensate for the residual adverse in different modes. For instance, residual traces of the 3D scene can present even when a switchable diffusive layer is used to nullify the 3D scene. The 2D layer can host an inverse of the said residual images for a more complete removal of the 3D scene. In a preferred variant, the part of the content and shade moved to the 2D layer, the compensation imagery, or the combination of them can be implemented into the content of the corresponding modes to make the device brighter, more energy efficient, more updatable, or bringing other effects while bringing little to no adverse effect on the intended content

However, the switching module can be otherwise configured.

### 3.5 Sensing and Interaction Module

The sensing module 500 functions to gather information about a viewer, a user, a physical environment, a device state, an installed light field scene, and/or any other suitable context so that the system can adapt presentation, switching behavior, calibration, and/or interaction behavior. In variations, one or more sensing elements can be mounted separate from, above, onto, within, behind, and/or around the optical stack, can be integrated into a housing or bezel, and/or can be remotely located but communicatively coupled to the controller. The sensing module can be used to detect viewer presence, head pose, gaze direction, eye position, user distance, proximity, room illumination direction, room illumination spectrum, room illumination intensity, touch location, gesture state, voice activity, cartridge identity, scene identity, alignment state, calibration targets, and/or any other suitable sensed condition. In examples involving removable or swappable static light field image generators, cartridge identifiers, fiducial detectors, QR-code readers, and/or machine-vision sensors can be used to determine which scene insert is installed, verify registration, retrieve corresponding compensation parameters, and/or trigger a corresponding playback mode or application state. In further variations, the sensing module can support engagement analytics, campaign logic, telepresence, conferencing, ambient-light coupling, single-viewer enhancement, and/or any other suitable function. In further variations, the sensing module can detect whether an inserted cartridge, optical subassembly, and/or other replaceable component is valid, correctly seated, and/or correctly aligned. The sensing module can further support automatic recalibration after replacement and can cooperate with the controller to limit or lock certain operations until a valid component is detected.

The sensing module can include one or more RGB cameras, IR cameras, time-of-flight cameras, ambient light sensors, microphones, proximity sensors, capacitive sensors, wireless-presence detectors, encoders, fiducial detectors, cartridge identifiers, QR-code readers, and/or any other suitable sensors.

In a variant, the sensing module 500 can support installation verification, registration, and calibration. For example, fiducial detectors, cartridge identifiers, QR-code readers, encoders, and/or machine-vision sensors can be used not only to determine which scene insert is installed, but also to verify registration of optical layers, retrieve corresponding compensation parameters, select corresponding media assets, and/or trigger a corresponding playback mode or application state. In some variations, the system can support user replacement of cartridges, service replacement of optical subassemblies, and/or field recalibration after replacement. Mechanical features such as magnets, rails, keyed openings, compression structures, locating pins, and/or coded cartridges can aid correct assembly, while the sensing module verifies seating, alignment, and/or component validity.

However, the sensing module can be otherwise configured (for example, such as in manner as described in U.S. Pat. No. 12,204,281 titled ‘SYSTEM AND METHOD FOR HOLOGRPAPHIC IMAGE DISPLAY’ issued on 21, Jan. 2025 which is incorporated in its entirety by this reference).

The interaction module 600 functions to enable a user, viewer, presenter, and/or passerby to interact with the displayed content, optical modes, and/or application logic of the system. In variations, the interaction module can additionally include one or more speakers, haptic elements, remote-control receivers, physical buttons, mobile-device interfaces, and/or any other suitable input and/or output structure. The interaction module can support direct touch interaction, non-contact gesture interaction, gaze-based interaction, voice-triggered interaction, proximity-gated interaction, and/or any other suitable interaction mode. In preferred hybrid-display examples, interaction can produce view-correct visual effects that originate at or near the two-dimensional layer and appear to spill onto, wrap around, and/or otherwise propagate across the three-dimensional light field scene, such as ripples, highlights, shadows, reflective effects, cursor effects, object responses, and/or other feedback. In such examples, calibration can bind dynamic two-dimensional coordinates to fixed light field geometry so that the feedback appears to reside within a shared three-dimensional volume rather than merely on a flat screen. In some variations, the interaction module can support contactless or near-contactless interaction with apparent three-dimensional interface elements presented as floating in front of the physical display surface by the static light field image generator. Because the hybrid display can present volumetric control elements such as buttons, sliders, or selection targets at apparent positions in front of the device, an infrared sensor array, time-of-flight proximity sensor, ultrasonic sensor, and/or other non-contact sensing element can detect user gestures or finger positions in free space and register the corresponding interaction without requiring physical contact with the display surface. This can be advantageous in medical, food-service, industrial, public-kiosk, and other environments where hygiene, glove compatibility, and/or minimization of surface contamination are priorities. Ultrahaptic, mid-air haptic, and/or audio effect feedback can optionally be combined with the non-contact sensing to provide tactile and/or auditory confirmation of interactions at apparent positions in space. In such implementations, the controller can calibrate a mapping between sensed free-space positions and apparent three-dimensional element positions so that interaction registration is spatially consistent with the perceived volumetric user-interface layout.

In variations, the sensing module and the interaction module can cooperate with the switching system, illumination system, two-dimensional image generator, and/or controller so as to initiate, modify, or terminate mode changes and content behaviors. For example, proximity sensors, wearable detection via short-range radios, wake-word audio, gaze detection, head-pose estimation, ambient-light sensing, and/or touch input can gate transitions between ambient signage and interactive-agent modes, between two-dimensional and three-dimensional modes, between one static scene and another, and/or between one level of three-dimensional intensity and another. Ambient-light sensing can additionally be used to drive shadow cues, highlight cues, reflection cues, color washes, and/or other lighting-consistency effects in the two-dimensional content, while gaze and head-pose sensing can be used to enhance look-around realism, personalize content, trigger localized three-dimensional reveals, and/or collect engagement metrics. In a variant, the head position of a viewer, observer, or camera can be used to compute the correct projected perspective of a content on the 2D layer to create a sense of 3D content using the head-coupled perspective technique. In some variations, one or more of the sensing modules and the interaction module can share hardware, software, firmware, and/or communication resources with the controller, and can be partially or wholly integrated into the controller while remaining functionally distinct within the system architecture.

In variations, the interaction module 600 can support telepresence, conversational-agent embodiments, virtual assistants, and/or AI-driven characters. In such variations, microphones, speakers, gesture sensors, gaze tracking, and/or other interaction structures can cooperate with a controller and/or backend system to allow a live or synthetic subject displayed by the two-dimensional image generator 200 to respond to a user while appearing within the three-dimensional environment generated by the static light field image generator 100.

The sensing module and the interaction module can, however, be otherwise suitably configured.

### 3.7 Controller

The controller 700 functions to coordinate operation of the system such that the static light field image generator, the two-dimensional image generator, the illumination system, the optional switching system, the optional sensing system, and the optional interaction system cooperate to generate a composite display experience having a static or quasi-static three-dimensional scene and dynamic two-dimensional content. In variations, the controller can further function to govern transitions between a three-dimensional mode, a two-dimensional mode, and/or one or more intermediate or mixed modes; to synchronize optical-stack state changes with content playback; to adapt system behavior in response to sensed conditions and/or user input; and/or to manage calibration, compensation, and content selection across the system.

The controller can include one or more processors, microcontrollers, GPUs, ASICs, FPGAs, networking devices, storage media, and/or other computing elements. The controller can execute content playback, dynamic compositing, render-pipeline control, switching control, timing control, calibration logic, sensor fusion, image warping, brightness correction, occlusion masking, view tracking, cartridge recognition, and/or any other suitable operations. The controller can be integrated into a housing, distributed among modules, remote from the display, cloud-coupled, and/or otherwise arranged.

In preferred variations, the controller can receive software-state information, user input, sensor triggers, schedules, and/or content-associated identifiers such as filename conventions, embedded metadata, playlist manifests, scene graph nodes, and/or other associated data, and can responsively determine whether corresponding content is to be presented in a two-dimensional mode, a three-dimensional mode, and/or at a selected three-dimensional intensity. In response, the controller can synchronize one or more optical-state changes including backlight activation or deactivation, edge-lit plate activation or deactivation, PDLC clear-state or scattering-state control, polarization-control timing or duty-cycle control, emissive-layer stimulation, retractable-layer actuation, movable-layer-spacing control, local brightness compensation, compensation-mask activation, peripheral masking, gamma adjustment, and/or any other suitable coordinated action, such that a viewer perceives a clean transition without objectionable transients.

In some variations, the controller can be implemented as a local media player, application processor, graphics subsystem, networked control unit, and/or distributed control architecture spanning local and remote compute resources. In some such variations, latency-sensitive functions such as timing control, sensor fusion, mode switching, and optical-state synchronization can be performed locally, while less time-sensitive functions such as content management, campaign logic, analytics, software updates, remote diagnostics, and/or fleet coordination can be performed remotely and/or in a cloud-coupled environment. In further variations, the controller can access and/or maintain one or more stored calibration tables, brightness maps, alignment maps, scene identifiers, cartridge identifiers, and/or per-installation configuration files, and can use such data to drive brightness-evenness correction, shadow and reflection mapping, aliasing mitigation, registration maintenance, scene-specific playback, and/or other suitable system behaviors. In still further variations, the controller can cooperate with cameras, proximity sensors, ambient-light sensors, microphones, touch layers, tracking systems (e.g., gaze-tracking, eye tracking, etc. where the tracking data can be used to modify the 2D and/or 3D operation such as in manner as described in U.S. Pat. No. 12,204,281 titled ‘SYSTEM AND METHOD FOR HOLOGRPAPHIC IMAGE DISPLAY’ issued on 21, Jan. 2025 which is incorporated in its entirety by this reference), fiducial detectors, QR-code readers, encoders, and/or other components to trigger engagement, personalize presentation, recognize installed scene modules, retrieve corresponding media assets, adapt content to ambient conditions, and/or support any other suitable system operation. In further variations, the stored calibration tables can include seam-management tables for tiled products, brightness-balance tables, drive ratios, stimulation strengths, polarization duty cycles, per-mode correction values, and/or other installation-specific data. The controller can retrieve and apply such values in response to detected scene modules, operating-mode changes, and/or service events.

In further variations, the controller 700 can synchronize optical switching with render-pipeline changes such as gamma shifts, brightness correction, occlusion-mask changes, ambient-light shadow changes, color correction, and/or masking, thereby reducing visible transients and improving perceived polish. In reflected, curved, and/or table-format variations, the controller 700 can additionally drive pre-warp, inversion, post-calibration, and/or other geometry-compensation functions so that the perceived three-dimensional geometry remains correct despite reflection, curvature, and/or non-vertical installation geometry.

In some variations, the controller 700 can additionally manage scene-specific and installation-specific data including lens-pitch variants, alignment tables, brightness maps, cartridge-specific parameters, reflection-compensation parameters, curvature-compensation parameters, and/or other stored calibration data. Such data can be used to drive brightness-evenness correction, aliasing mitigation, registration maintenance, scene-specific playback, and/or other suitable system behaviors. In still further variations, the controller can manage field recalibration after replacement of a cartridge and/or optical subassembly, can validate inserted components using sensed identifiers and/or alignment information, can load corresponding scene-specific and installation-specific parameters, and can inhibit or limit selected operations until a valid component configuration is confirmed.

However, the controller can be otherwise configured.

### 4. Method

### 4.1 Method Overview

The method functions to generate and present a composite display output in which a static or quasi-static light field image generator provides at least part of a perceived three-dimensional scene and a two-dimensional image generator provides dynamic two-dimensional content that is spatially coordinated with the perceived three-dimensional scene. In preferred variations, the method can further function to selectively operate the system in a three-dimensional mode, a two-dimensional mode, and/or one or more intermediate modes; to adapt the composite output based on sensed viewer state, ambient conditions, installed scene modules, and/or interaction inputs; and/or to coordinate illumination, switching, compositing, calibration, and presentation so that the composite output reads as a coherent shared spatial volume rather than a simple layer stack.

In a first variant, the method can be used to generate a standalone static light field product in which a three-dimensional scene is authored, encoded, and embodied in one or more physical media layers, without requiring a dynamic two-dimensional display during use. In a second variant, the method can be used to generate and operate a hybrid display in which dynamic two-dimensional media appears visually seated in, behind, in front of, and/or otherwise integrated with the three-dimensional scene. In a third variant, the method can be used to operate a switchable display that selectively behaves as a multi-view three-dimensional display, a substantially conventional two-dimensional display, and/or a partially mixed two-dimensional/three-dimensional display. In some examples of the third variant, the three dimensional content can be provided on a screen (e.g., 3D display) in addition to or as an alternative to a physically encoded and/or static 3D content (e.g., can include design features of a display such as disclosed in U.S. patent application Ser. No. 19/513,295 titled ‘AUGMENTED SUPERSTEREOSCOPIC DISPLAY’ filed 23, Feb. 2026 which is incorporated in its entirety by this reference).

In an example, the method can receive source information for a target three-dimensional scene, generate a multiview and/or ray-based light field representation of that scene, form a static light field image generator using one or more physical structures that embody and/or reconstruct the light field representation, such as one or more encoded layers used with one or more optical steering structures, a structured light field element (e.g., an integrated holographic, diffractive, etched, embossed, exposed, etc. light field element), and/or other suitable static light field image generator,, arrange the static light field image generator relative to a two-dimensional display layer and associated illumination and switching elements, generate dynamic two-dimensional content mapped to the three-dimensional scene, optionally sense a viewer, ambient environment, and/or installed scene module, optionally change the operating mode of the system, and present the resulting composite output to one or more viewers and/or to a camera.

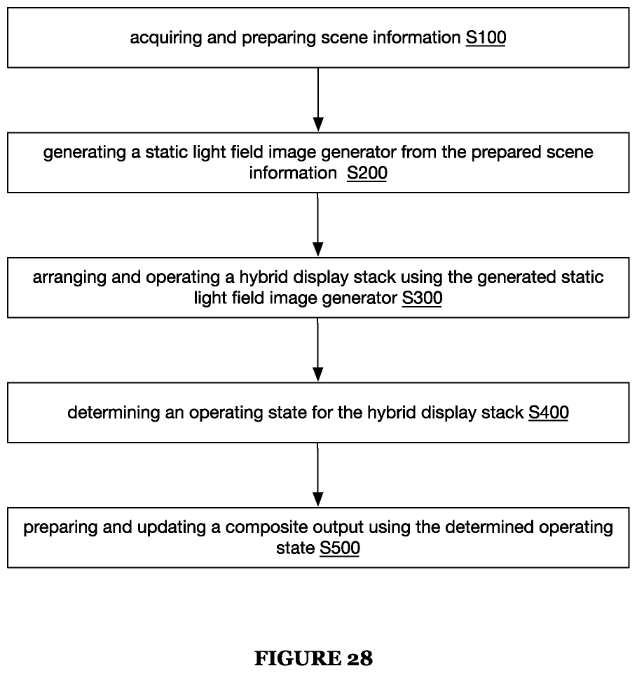

As shown for example in FIG. 28, the method can include: acquiring and preparing scene information S100; generating a static light field image generator from the prepared scene information S200; arranging and operating a hybrid display stack using the generated static light field image generator S300; determining an operating state for the hybrid display stack S400; and presenting and updating a composite output using the determined operating state S500. However, the method can additionally or alternatively include any other suitable steps, and/or any suitable steps can be performed in any suitable order.

### 4.2 Acquiring and Preparing Scene Information

Acquiring and preparing scene information S100 functions to obtain and prepare information from which a static light field scene and, where applicable, coordinated dynamic two-dimensional content can be generated. The scene information can include mesh data, point clouds, CAD data, captured photographs, structured-light captures, depth maps, disparity maps, radiance field data, neural scene representations, Gaussian splats, game-engine scenes, artist-authored scenes, symbolic scenes, ray-traced scenes, semi-realistic scenes, and/or any other suitable scene information. The scene information can be received from a manufacturer, content author, content studio, user, remote service, calibration workflow, and/or any other suitable source.

S100 can additionally include preparing the scene information for a selected target implementation. For example, S100 can include selecting a target lens pitch, view count, ray count, parallax arrangement, view distance, view cone, scene extent, zero-parallax plane, display size, stack ordering, projector or panel configuration, reflective or direct-view configuration, color separation, and/or any other suitable target format characteristic. S100 can also include selecting how the static scene is to relate to dynamic content, such as whether the static scene is to act as a foreground, background, alcove, enclosure, stage, product volume, world, and/or other spatial context for the dynamic content.

In variations, S100 can additionally include preprocessing the scene information for manufacturability and/or perceptual consistency, such as by selecting a rendering style, modifying color based on depth or disparity, reducing expected crosstalk, compensating for anticipated print limitations, view condition and/or otherwise conditioning the scene information. The prepared scene information generated in S100 can then be used in S200 to generate a static light field representation and corresponding physical encoding.

### 4.3 Generating a Static Light Field Image Generator From the Prepared Scene Information

Generating a static light field image generator from the prepared scene information S200 functions to convert the prepared scene information from S100 into a physical structure that generates a perceived three-dimensional scene. In preferred variations, S200 can include generating a static light field representation from the prepared scene information, generating one or more encoded media layers based on the static light field representation, and forming a static light field image generator from the encoded media layers and one or more optical steering structures.

Generating the static light field representation can include, using the prepared scene information from S100, rendering a plurality of views from different perspectives (example shown in FIG. 2), sampling rays, generating depth maps, determining disparities, selecting intended view cones, view distance, selecting angular ranges, selecting scene extents, and/or performing any other suitable light field authoring operation. In perspective-based variations, virtual cameras can be placed across one axis or two axes and corresponding rendered views can be interlaced or otherwise encoded. In ray-based variations, samples of a four-dimensional light field and/or equivalent angular information can be encoded directly.

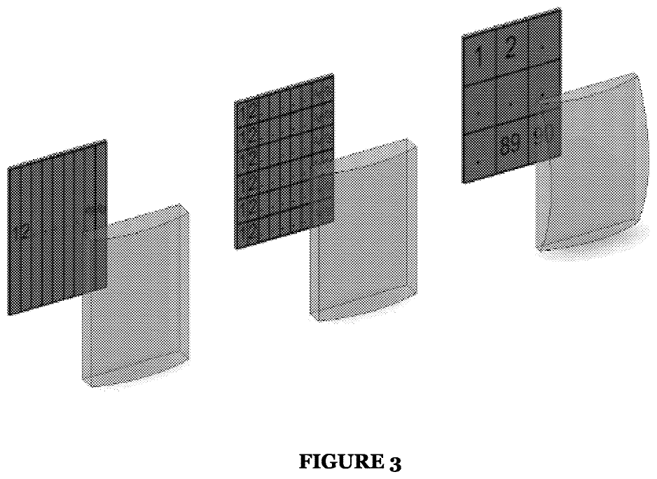

Generating one or more encoded media layers can include producing a monochrome encoding, producing a color encoding, producing an auxiliary angular layer, producing an etched pattern, producing a holographic pattern, producing exposure masks, and/or producing any other suitable encoded structure (example shown in FIG. 3 through FIG. 8). In preferred print-based variations, a high-resolution monochrome layer can encode grayscale light field information at a relatively high view count and/or ray count, and an optional color layer can encode color information at the same or a lower view count and/or ray count. In such variations, the color encoding can be based on depth-aware, disparity-aware, crosstalk-aware, and/or print-process-aware preprocessing performed in S100.

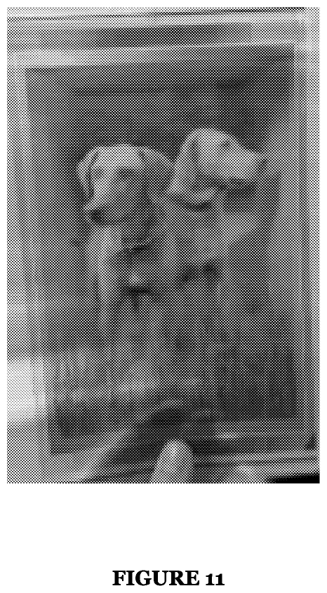

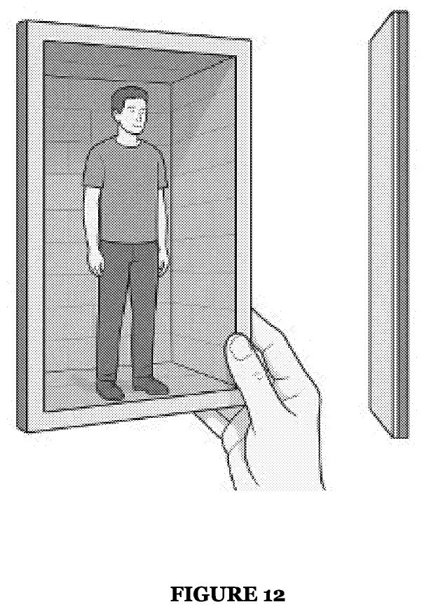

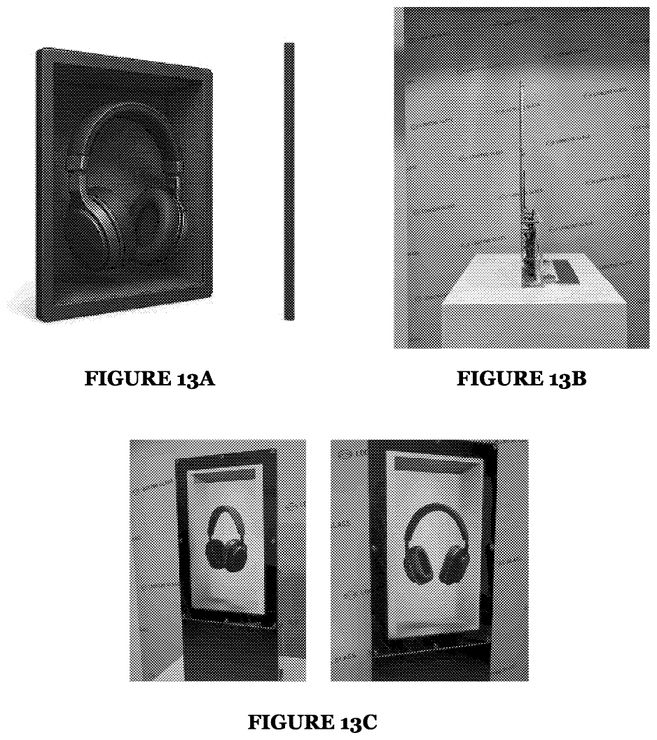

Forming the static light field image generator can include aligning and coupling one or more encoded layers with one or more optical steering structures such as a lenticular array, fly-eye array, microlens array, parallax barrier, diffractive array, etched redirection structure, holographic optical structure, and/or any other suitable structure. The encoded layers can be printed, exposed, etched, embossed, engraved, replicated, deposited, or otherwise formed, and can be bonded, laminated, fused, registered, and/or otherwise associated with the steering structure using any suitable process. The resulting static light field image generator formed in S200 can then be arranged with one or more dynamic-display (example shown in FIG. 11, 12, 13A-C), illumination, and/or switching components in S300.

### 4.4 Arranging and Operating a Hybrid Display Stack Using the Generated Static Light Field Image Generator

Arranging and operating a hybrid display stack using the generated static light field image generator S300 functions to combine the static light field image generator generated in S200 with one or more dynamic-display, illumination, and/or switching components so that dynamic two-dimensional content can be visually integrated with the static three-dimensional scene. In preferred variations, S300 can include arranging the static light field image generator relative to one or more display, illumination, and/or switching layers, generating and/or receiving dynamic two-dimensional content to be used with the static light field image generator, and spatially coordinating the two-dimensional content with the static three-dimensional scene.

Arranging the hybrid display stack can include placing the static light field image generator generated in S200 relative to a two-dimensional image generator positioned behind the static light field image generator, in front of the static light field image generator, between portions of a light field stack, in a projected arrangement, in a reflective arrangement, in a transparent-display arrangement, and/or in any other suitable optical relationship. The two-dimensional image generator can include an open-cell LCD, OLED, transparent OLED, microLED, miniLED, electrophoretic display, projector, persistence-of-vision display, and/or any other suitable display. The stack can further include a rear backlight, an edge-lit plate, a diffuser, a switchable diffuser, gain films, angular-conditioning films, touch overlays, sensing elements, and/or any other suitable components.

Generating and/or receiving dynamic two-dimensional content can include rendering or receiving video, user-interface content, conversational characters, agents, products, people, labels, subtitles, lighting effects, reflections, shadows, recorded media, live media, segmented live-video subjects, interactive application, video games, and/or any other suitable dynamic content. Spatially coordinating the two-dimensional content with the static three-dimensional scene can include shadow mapping, reflection mapping, occlusion masking, alpha compositing, edge matching, color matching, geometric warping, brightness adjustment, viewpoint correction, runtime masking, and/or any other suitable spatial coordination so that the dynamic content appears to reside within, behind, in front of, and/or otherwise integrated with the static three-dimensional environment.

In examples, front ridges, alcove boundaries, stage lips, and/or other scene geometry represented by the static light field image generator can receive mapped shadows, highlights, reflections, and/or spotlight effects from the two-dimensional content, thereby improving the coherence of the composite scene. Once the hybrid display stack has been arranged and the dynamic content has been coordinated with the static scene in S300, the method can proceed to S400 to determine how that hybrid stack is to be operated under current conditions.

### 4.5 Determining an Operating State for the Hybrid Display Stack

Determining an operating state for the hybrid display stack S400 functions to determine how the hybrid display stack arranged in S300 is to be operated under current viewer, environment, content, and/or device conditions. In preferred variations, S400 can include sensing viewers and/or ambient conditions, sensing an installed scene module and/or cartridge, determining whether the system is to operate in a three-dimensional mode, a two-dimensional mode, and/or one or more intermediate modes, and coordinating the corresponding system behavior.

Sensing can include determining head pose, eye pose, approximate viewer location, gaze direction, viewer presence, proximity, ambient light direction, ambient light spectrum, ambient light intensity, color temperature, touch state, gesture state, voice activity, wake words, presence states, cartridge identity, scene identity, alignment state, calibration targets, and/or any other suitable state. An installed light field cartridge or removable scene module can include a QR code, electrical identifier, optical code, RFID tag, NFC tag, magnetic pattern, and/or any other identifier that the system can recognize to load corresponding dynamic content, calibration data, shadow maps, ambient-light rules, usage restrictions, and/or other associated information.

Determining the operating state can include selecting among a three-dimensional mode, a two-dimensional mode, and one or more intermediate modes. In a dual-illumination example, the system can operate in the three-dimensional mode by activating a rear backlight and deactivating an edge-lit plate, and can operate in the two-dimensional mode by deactivating the rear backlight and activating the edge-lit plate so that its light washes out angular cues from the static light field image generator. In another example, a switchable diffuser such as PDLC can be driven between a lower-haze state for three-dimensional viewing and a higher-haze state for two-dimensional viewing. In still other examples, operating-state selection can involve polarization-based nullification, emissive washout, retractable or repositionable layers, movable layer spacing, localized reveals, software-defined masking, and/or other switching arrangements.

In variations, S400 can additionally include adapting the dynamic two-dimensional content and/or illumination to the sensed context. For example, the controller can adapt the dynamic content for a tracked viewer while leaving the static light field background multi-view and generally stable for bystanders; can alter shadows, highlights, reflections, color washes, background intensity, and/or other rendered cues so that the displayed content better matches the physical environment; and can initiate operating-mode changes in response to user input, sensing, schedules, application state, metadata, filename conventions, playlist manifests, and/or other triggers. The determined operating state from S400 can then be used in S500 to drive the stack and present the composite output in the selected mode.

### 4.6 Presenting and Updating a Composite Output Using the Determined Operating State

Presenting and updating a composite output using the determined operating state S500 functions to present the hybrid display stack arranged in S300 according to the operating state determined in S400, thereby outputting a coordinated three-dimensional and/or two-dimensional scene to one or more viewers and/or to a camera. In preferred variations, S500 can include driving the illumination system, driving the two-dimensional image generator, optionally actuating one or more switching elements, and presenting the resulting combined output.

In some variations, S500 can include presenting a multi-view static light field environment together with dynamic two-dimensional subjects, overlays, and/or interface elements when S400 selected a three-dimensional mode. In other variations, S500 can include presenting substantially conventional two-dimensional video, text, menus, subtitles, reading content, and/or presentations when S400 selected a two-dimensional mode in which the three-dimensional scene is reduced, washed out, bypassed, or otherwise obscured. In still further variations, S500 can include presenting mixed outputs, such as localized three-dimensional reveals, partial fades, staged transitions, privacy modes, and/or other intermediate operating states.

Interaction-driven and/or context-driven updates during S500 can include touch-triggered view-correct effects, gaze-responsive perspective enhancement, proximity-gated mode changes, ambient-light-aware shading updates, voice-triggered reveals, personalized content loading, and/or any other suitable interactions. In examples, a touch event can trigger a ripple, highlight, shadow, or reflective effect that appears to spill from the two-dimensional plane into the three-dimensional environment, a proximity event can wake the system from an ambient state into a more immersive conversational state, and a voice command can request a switch from a reading mode to a holographic mode. In such variations, the method can loop back from S500 to S400 to determine an updated operating state and/or can loop back from S500 to S300 to update the coordinated dynamic content relative to the static three-dimensional scene.

The method can, however, include any other suitable steps and/or be otherwise suitably performed.

### 5. Exemplary Applications

The system can be applied in a wide range of industries and contexts. In preferred variations, the same underlying architecture can be adapted across such contexts by selecting an appropriate static light field scene, an appropriate two-dimensional content source, an appropriate stack arrangement, and, where useful, an appropriate sensing, interaction, and/or switching configuration. In this manner, the system can be configured to prioritize thinness, depth realism, ordinary two-dimensional readability, low compute, interaction, swappability of scenes, and/or any other suitable product objective depending on the intended application.

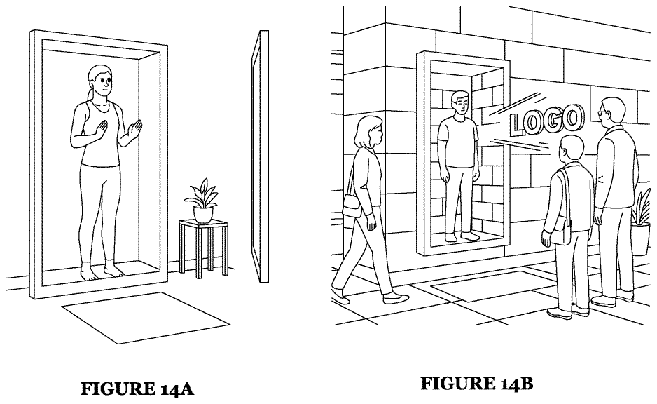

A home assistant device can present an embodied conversational agent, shopping content, alerts, weather, music visualizers, home controls, and/or personal media in an apparently volumetric alcove or scene (example shown in FIG. 14A). In such variations, the static light field image generator can provide a persistent room, alcove, stage, fireplace-like nook, and/or other architectural or thematic three-dimensional environment in which a dynamic conversational agent, avatar, shopping object, alert card, and/or other dynamic subject appears to reside. The device can remain in a calm two-dimensional mode most of the time, for example to present ordinary readable text, controls, widgets, media playback, notifications, and/or low-distraction home-status information, and can reveal a more immersive three-dimensional mode only when useful, such as when a user approaches, speaks a wake word, requests a shopping visualization, receives a high-priority alert, and/or initiates a richer conversational interaction. In further variations, microphones, cameras, proximity sensors, touch layers, and/or ambient-light sensing can be used to trigger or refine such transitions, and dynamic shadows, reflections, highlights, and/or masking effects can be mapped onto the two-dimensional content so that the displayed agent or media appears visually seated within the three-dimensional environment rather than merely overlaid on a flat screen. In some low-cost embodiments, an apparent-two-dimensional mode can be achieved using software-defined peripheral masking in lieu of a dedicated optical switching layer.

A retail or out-of-home signage device can alternate between ordinary promotional content and attention-capturing three-dimensional reveals (example shown in FIG. 14B). In such variations, the static light field image generator can provide a three-dimensional product alcove, showcase volume, branded scene, stage, cityscape, curtain-framed environment, and/or other campaign-specific spatial context, while the two-dimensional layer provides dynamic pricing, offers, calls to action, promotional video, embodied agents, animated products, seasonal messaging, and/or other campaign content. Seasonal or campaign-specific scenes can be swapped with cartridges, scene modules, and/or other replaceable static inserts, and corresponding media assets and compensation parameters can be loaded automatically using identifiers, fiducials, and/or other sensing mechanisms. Sensors can trigger reveals only when a viewer is nearby, thereby reducing distraction and energy usage, and can additionally support gaze-responsive content, proximity-gated switching between two-dimensional and three-dimensional modes, campaign analytics, and/or localized three-dimensional reveals that occur only when useful. In some deployments, the system can remain in an ordinary two-dimensional mode for standard advertising playback and switch into a more immersive three-dimensional mode for product reveals, characters, and/or branded moments, thereby preserving readability while still supporting attention capture.

A telepresence or conferencing device can display a participant or agent on a two-dimensional layer while the static light field image generator provides an apparent surrounding volume, stage, or room. In such variations, a live or recorded participant, an AI agent, a remote expert, and/or another dynamic subject can be segmented from a background and composited into a static three-dimensional room, alcove, stage, booth, desk scene, and/or other surrounding environment so that the subject appears to occupy a more spatially convincing volume than in a conventional flat-screen video call. Optional eye tracking can improve local realism for a primary viewer without sacrificing a generally stable multi-view scene for others in the room, for example by adapting dynamic facial, gaze-dependent, or head-coupled perspective content for one tracked viewer while leaving the static multiview background broadly viewable by bystanders. The device can be especially useful in home offices, huddle rooms, phone booths, kiosks, and/or other tight spaces that are poorly suited to Pepper's Ghost arrangements or bulky shadow-box displays. In further variations, the system can switch between a more conventional two-dimensional presentation mode for slides, screen sharing, and/or text-heavy material and a more immersive three-dimensional mode for calls, demos, or product review.

A vehicle display can provide conventional driving information in a two-dimensional mode and more immersive assistant, navigation, or entertainment content in a three-dimensional mode. In such variations, the system can be implemented as an in-dash display, a center-console display, a passenger entertainment display, and/or a reflected heads-up-display system in which the hybrid optical stack is viewed through a combiner. Reflected heads-up-display variations can place three-dimensional cues around ordinary indicators at useful apparent depths, for example by pre-warping and/or inverting content so that, after reflection, navigation cues, assistant embodiments, warnings, music visualizers, and/or other three-dimensional elements appear spatially coordinated with conventional two-dimensional driving indicators. A two-dimensional mode can be used when conventional readability, safety, and ordinary driving information are prioritized, while a three-dimensional mode can be used for richer assistant presence, navigation context, entertainment experiences, and/or other applications appropriate to the use state of the vehicle. In some variations, ambient-light sensing, driver input, schedule state, and/or drive state can influence transitions among such modes. In some variations, a head-coupled perspective technique can be used for the driver or a selected viewer such that the content on the 2D layer maps to the 3D scene more realistically.

A mobile or foldable device can include a smaller hybrid display window, a case-mounted module, or a removable cover carrying a light field image generator. Such devices can provide a distinctive holographic presence effect without requiring the full device display to become a fully dynamic light field display. In some variations, a small hybrid module can be integrated into a phone, tablet, foldable device, case, peripheral, and/or display cover so as to present a miniature embodied agent, spatial widget, product showcase, assistant embodiment, and/or other dynamic subject within a static three-dimensional alcove or scene. In other variations, a user-removable cover carrying the static light field image generator can be adhered to or otherwise placed over an existing device display so as to add a three-dimensional visual element without permanently modifying the device. Such mobile embodiments can support power-saving or readability-oriented two-dimensional modes, attention-capturing three-dimensional modes, and/or proximity-triggered transitions therebetween, and can be especially useful for secondary displays, companion-agent displays, foldable-device outer screens, and/or novelty or premium consumer-device accessories. In a variation, a head-coupled perspective technique can be used such that the content on the 2D layer maps to the 3D scene more realistically. In a variation, the 2D content can react to the gyroscope and/or other appropriate sensors on a mobile device such that the content on the 2D layer reacts to changes in the device's orientation and/or location to realize a more realistically effect.

A holographic fireplace or decorative home display can combine a static three-dimensional alcove or architectural scene with dynamic flames, smoke, agents, products, and/or other media. In such decorative and experiential variations, the static light field image generator can provide an architectural surround, textured alcove, mantel scene, showcase niche, cave, laboratory, gallery, and/or other themed three-dimensional environment, while the two-dimensional layer provides dynamic fire, smoke, embers, lighting effects, seasonal decorations, assistant embodiments, products, historical overlays, and/or other dynamic content. A museum or educational exhibit can use the system to present layered history, anatomy, engineering cutaways, and/or preserved artifacts with more depth than conventional prints and less bulk than shadow-box displays. In such exhibit variations, the system can present scientific, historical, engineering, and/or cultural material with a thin-form-factor volumetric effect, can alternate between ordinary explanatory two-dimensional text or diagrams and more immersive three-dimensional reveals, and can support interactive exploration through touch, gesture, gaze, proximity, and/or audio triggers. In both decorative and exhibit contexts, the hybrid arrangement can provide a stronger impression of depth and presence than a conventional flat display while remaining substantially thinner, easier to ship, and easier to install than deeper showcase-style systems.

However, the system can be suitably applied otherwise.

### 6. Illustrative Examples

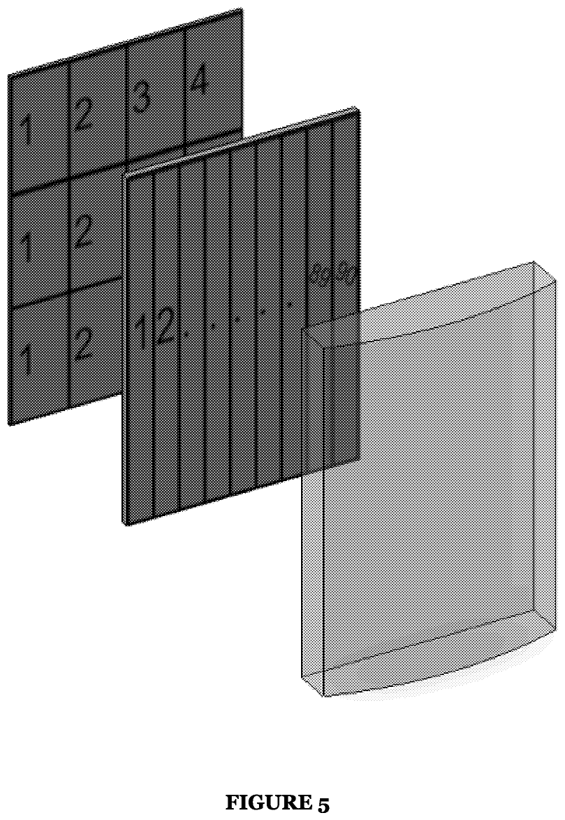

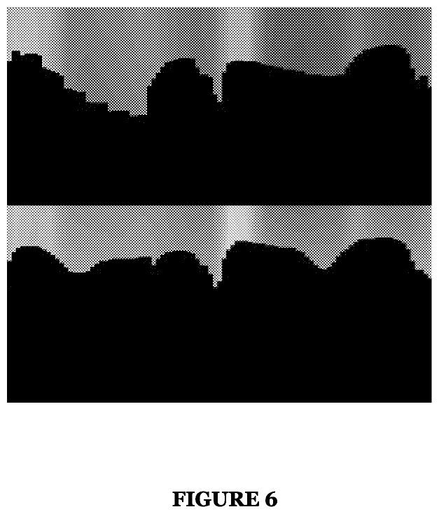

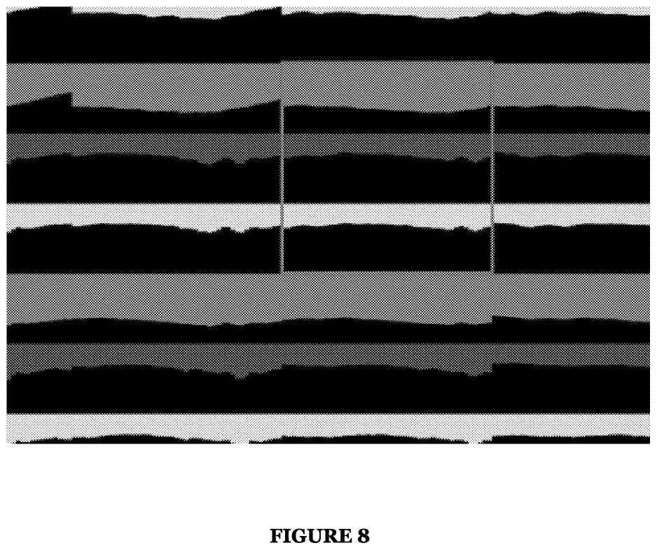

In an illustrative example, a high-resolution monochrome layer encoded with anisotropic pixels is paired with a lower-resolution color layer and aligned with a lenticular lens, resulting in a light field print having substantially greater apparent depth and view continuity than a conventional single-layer color lenticular print. In such an example, the monochrome layer can carry high-density luminance and angular information at a substantially higher effective spatial resolution than a color print process, while the color layer can provide chrominance information at the same or a lower view count. The anisotropic pixels can be shaped and arranged such that one dimension predominantly carries angular separation and another dimension predominantly carries grayscale and/or spatial information, thereby enabling many more encoded views under a lenticule than a conventional square-pixel encoding (example shown in FIGS. 4, 5 and 6). For example, under a lenticular lens providing horizontal parallax, a relatively narrow width can separate adjacent perspectives while an elongated extent can encode grayscale by varying a size, height, density, position, area coverage, and/or distribution of a darkened region. In such variations, the total darkened area can correspond to a desired grayscale level while the angular placement of the anisotropic pixel under the optical structure can correspond to a desired view direction, thereby increasing the number of available views under a lens relative to a conventional square-pixel encoding while preserving grayscale representation. In preferred variations, the color layer can be laminated to, printed onto, registered with, and/or otherwise optically associated with the monochrome layer (example shown in FIG. 6), and can be implemented as an interlaced multiview print, a color-strip arrangement (as shown for example in FIG. 8 for an RGB and black example, but other coloring options, like CMYK, can also be used), in which color information for different views and/or different color channels is arranged in strips so as to provide chrominance information in registration with the higher-resolution monochrome light field information, a selectively transparent chrominance layer, and/or another suitable color-bearing structure (example shown in FIG. 5). The resulting print can therefore provide substantially smoother look-around, deeper apparent volume, improved angular continuity, and/or reduced crosstalk relative to a conventional single-layer color lenticular print of similar size.

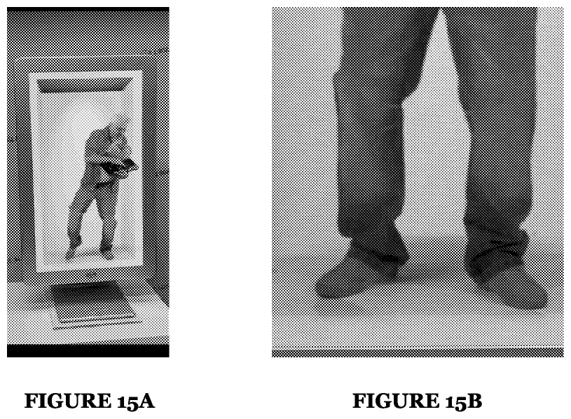

In an illustrative example, a hybrid display includes a static light field image generator, an open-cell LCD, and a rear backlight, where dynamic video of a person is composited with shadow and reflection cues so the person appears to stand within a printed three-dimensional alcove (e.g., matching an environment from the 3D print, example shown in FIG. 15A-B). In such an example, the static light field image generator can provide a persistent three-dimensional enclosure, alcove, stage, room, and/or other spatial environment, while the open-cell LCD provides dynamic video of a live or recorded person, agent, or other subject. The rear backlight can illuminate the static light field image generator so that the printed three-dimensional environment remains perceptible behind and/or around the dynamic subject. The dynamic video can be segmented from a background, color-adjusted, brightness-adjusted, geometrically mapped, and/or otherwise coordinated with the static scene. Relatedly, dynamic shadows, reflections, highlights, masking effects, and/or other effects (e.g., lighting, framing, etc. effects) can be generated so that the person appears visually seated within the three-dimensional alcove rather than overlaid on a flat layer. In some variations, fixed portions of the printed scene can further be used to generate occlusion masks and/or composition boundaries that improve spatial coherence of the hybrid presentation.

In an illustrative example (as shown for instance in FIG. 29), a dual-illumination variation includes a rear backlight for a three-dimensional mode and an edge-lit plate for a two-dimensional mode, such that the same device behaves as a conventional screen in a first mode and a hybrid light field display in a second mode. In such an example, the rear backlight can illuminate the static light field image generator in a three-dimensional mode so that multiview depth cues remain perceptible and the static light field scene provides a background, enclosure, alcove, and/or other spatial context for dynamic two-dimensional content. In a two-dimensional mode, the rear backlight can be deactivated, and the edge-lit plate can be activated to introduce light from the side and redistributing the light across the plate, thereby causing the same optical stack to read substantially as a conventional two-dimensional display. The edge-lit plate can include a planar light guide with localized frustration structures, screened coatings, micro-dot extraction features, micro-prism extraction features, and/or other light-extraction structures selected to improve illumination uniformity, reduce residual view lobes, and avoid objectionable features such as aliasing and color shift. In further variations, the transition between such modes can be synchronized with content changes so that the device switches cleanly between reading-oriented two-dimensional use and more immersive three-dimensional presentation. In preferred implementations, backlight drive can be increased in synchronization with the higher-haze PDLC state (and lowered in lower-haze PDLC states) so that the two-dimensional mode and the three-dimensional mode appear substantially brightness-matched to a viewer.

In an illustrative example, one or more polymer-dispersed liquid crystal (PDLC) layers positioned between a two-dimensional display and a static light field image generator is driven to a transparent state for a three-dimensional mode and to a diffusive state for a two-dimensional mode. In such an example, the PDLC layer can be substantially clear, low-haze, and/or minimally scattering in the three-dimensional mode so that directional light transport from the static light field image generator is preserved and multiview depth cues remain visible to one or more viewers. In the two-dimensional mode, the PDLC layer can be driven into a more scattering or higher-haze state by reducing or removing an applied electric field so that liquid-crystal domains become less aligned and directional light field information is disrupted, causing the display to behave substantially like a conventional full-surface-area two-dimensional screen (e.g., with a diffusive halo). This approach can be especially but not exclusively useful in consumer-device and signage applications in which ordinary video, text, menus, and/or user-interface content are to be shown across substantially the full display area at some times, while a three-dimensional hybrid effect is desired at other times. In some implementations, backlight drive, brightness compensation(e.g., using an edge lit plate), local equalization, and/or other compensations can be adjusted in synchronization with the PDLC state so that brightness differences between the two-dimensional and three-dimensional modes are reduced.

In an illustrative example(as shown for example in FIG. 27), a polarization-encoded three-dimensional layer is paired with a polarization control panel that time-multiplexes polarization states to nullify or modulate scene visibility. In such an example, different regions and/or components of the three-dimensional layer can be associated with different polarization responses, and the polarization control panel can time-multiplex, spatially vary, and/or otherwise control polarization to alter relative brightness of scene regions and background regions. By doing so, the controller can reduce contrast that would otherwise communicate the static three-dimensional scene, thereby suppressing scene visibility in a two-dimensional mode, partially modulating scene visibility in an intermediate mode, and/or restoring stronger scene visibility in a three-dimensional mode. As another implementation, an inversed image can be realized by polarization management, creating a 3D scene at an inversed brightness where, for instant, the object is brighter than the background. In some such implementations, polarization duty cycle, drive ratios, associated calibration values, and/or other calibration information can be determined during manufacturing and can optionally be updated in the field to compensate aging, nullification mismatch, and/or other residual non-uniformities. In further variations, layer ordering, substrate selection, and/or other polarization-aware construction choices can be selected to reduce polarization-driven artifacts and improve mode quality.

In an illustrative example (as shown for example in FIG. 26A, FIG. 26B, and/or FIG. 26C), a reposition mechanism (e.g., belt mechanism) carries multiple three-dimensional cartridges (e.g., 3D prints) and a blank (e.g., opaque, transparent, diffusive, etc.) segment, thereby allowing selection among multiple scenes or full removal of the three-dimensional scene. In such an example, each carried segment can include a different static light field image generator corresponding to a different alcove, room, stage, product showcase, and/or other three-dimensional scene, while the blank segment can provide a mode in which no three-dimensional scene is presented. The repositioning mechanism can be implemented using one or more rollers, guides, rails, indexed transport structures, cassettes, and/or other motion systems, and can position a selected scene in the optical path under controller control. In some variations, fiducials, encoders, cartridge identifiers, and/or other sensing structures can verify the position and identity of the selected segment so that corresponding dynamic content, calibration data, and/or operating parameters are loaded automatically. Such an arrangement can be particularly but not exclusively useful in signage, advertisement, retail, museum, seasonal, and/or campaign-based deployments where different static three-dimensional scenes are to be selected without replacing the full device.

In an illustrative example, a software-only apparent two-dimensional mode darkens the peripheral region of the displayed content so that a fixed three-dimensional alcove scene becomes much less perceptible while a central active region remains readable. In such an example, the strongest fixed depth cues of the static light field image generator can be located near edges, corners, and/or outer frame regions of the visible scene, such as in an alcove or framed environment. When a conventional two-dimensional presentation is desired without adding a dedicated switchable optical layer, the system can apply a software-defined peripheral mask to content shown on the two-dimensional layer. The mask can define a central active region used for primary two-dimensional content such as text, menus, video, and/or user-interface content, and an outer border region in which brightness, contrast, blur, color, and/or tone are modified to suppress visibility of the fixed three-dimensional environment. In preferred implementations, the border region can be feathered and/or vignetted to avoid a harsh edge. In this way, the display can read substantially like an ordinary two-dimensional screen over the central active region despite continued physical presence of the static three-dimensional layer in the stack. As a variant, the 2D content can selectively cover higher contrast regions in the 3D scene, like the sharp edges of an alcove for instance, such that the exposed area appears to be sufficiently even.

In an illustrative example, a reflected heads-up-display variation pre-warps a hybrid light field scene so that the reflected output presents correctly through a vehicle combiner. In such an example, the static light field image generator can provide a persistent three-dimensional spatial context while the two-dimensional layer provides dynamic navigation cues, assistant embodiments, warnings, entertainment elements, and/or other dynamic content. Because the combined output is viewed through a reflective combiner, mirror, windshield element, and/or other reflective optic, the generated content can be pre-warped, inverted, and/or otherwise geometrically compensated before display so that the reflected result appears correctly oriented and at a desired apparent depth relative to a vehicle interior and/or road scene. In some variations, the reflected implementation can switch between a more conventional two-dimensional driving-information mode and a more immersive three-dimensional mode depending on drive state, user input, safety condition, and/or other context.

In an illustrative example, a case-mounted module for a mobile device presents a small, embodied agent within a static light field scene, with proximity-triggered switching between an energy-saving two-dimensional mode and an attention-capturing three-dimensional mode. In such an example, the case-mounted module can include a compact static light field image generator providing a miniature room, alcove, stage, and/or other spatial context, and a corresponding two-dimensional display region can present a small, animated character, conversational agent, shopping object, status widget, and/or other dynamic subject within that context. The module can be integrated into a case, accessory, cover, foldable-device window, and/or secondary display structure without requiring the full device display to become a fully dynamic light field display. In some variations, a proximity sensor, touch input, user command, schedule state, notification state, and/or other trigger can place the module in a lower-power or reading-oriented two-dimensional mode most of the time and can switch the module into a more attention-capturing three-dimensional mode when presence, alerting, branding, novelty, and/or richer interaction is desired. In further variations, the static scene can be removable or replaceable so that the accessory can present different themed three-dimensional environments over time.

The foregoing illustrative examples are provided by way of example only and are not intended to limit the scope of the invention. A person skilled in the art will recognize from the previous detailed description, figures, and claims that modifications, substitutions, rearrangements, and changes can be made to the illustrated embodiments without departing from the scope of the invention. The system and associated methods can, however, be otherwise suitably configured and/or otherwise suitably performed.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference (e.g., within 0.001%, 0.01%, 0.1%, 1%, 5%, 10%, 20%, 30% of a reference), and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A display system, comprising:
a static physical encoding of a three-dimensional scene, wherein the physical encoding is generated from a plurality of 2D views corresponding to different perspectives of the three-dimensional scene;
a parallax generator aligned with the static encoded print and configured to direct each 2D view of the plurality of 2D views toward a respective viewing direction such that a first 2D view is presented at a first viewing position and a second 2D view is presented at a second viewing position that is different from the first viewing position;
a dynamic 2D screen disposed with the static physical encoding in an optical stack; and
an illumination system configured to illuminate the static physical encoding;
wherein the dynamic 2D screen is positioned such that a portion of a time-varying 2D image content is visually composited with the three-dimensional scene such that the time-varying 2D image content appears within the three-dimensional scene.

2. The display system of claim 1, wherein the static physical encoding is a print or lithographic plotting, wherein the parallax generator comprises a lenticular array.

3. The display system of claim 2, wherein the static physical encoding comprises:
a monochrome layer encoding grayscale light field information at a first view count; and
a color layer encoding color information at a second view count that is lower than the first view count.

4. The display system of claim 1, wherein the static physical encoding comprises anisotropic pixels wherein:
perspective information for a given anisotropic pixel is encoded along a first axis; and
grayscale level for a corresponding perspective is encoded along a
second axis orthogonal to the first axis.

5. The display system of claim 1, wherein a portion of the static physical encoding includes regions having greater light transmissivity than surrounding portions of the static physical encoding, wherein the regions are aligned with corresponding regions of the dynamic 2D screen.

6. The display system of claim 1, further comprising an optical diffuser disposed between the static physical encoding and the dynamic 2D screen.

7. The display system of claim 1, further comprising a second static physical encoding of a second three-dimensional scene that is different from the three-dimensional scene, and a repositioning mechanism configured to selectively position one of the static physical encoding or the second static physical encoding in the optical stack.

8. The display system of claim 1, wherein a periodic structure of the parallax generator is rotationally offset relative to a periodic structure of the dynamic 2D screen.

9. The display system of claim 1, wherein the parallax generator comprises a first parallax-generating layer to provide parallax along a first axis and a second parallax-generating layer to provide parallax along a second axis orthogonal to the first axis.

10. The display system of claim 1, wherein the physical encoding encodes a first portion of shading information for the three-dimensional scene, and wherein the dynamic 2D screen is configured to display a second portion of shading information that is substantially view-invariant across a plurality of the 2D views, and wherein the first portion of shading information and the second portion of shading information combine to represent the three-dimensional scene.

11. A display system comprising:
a static three-dimensional physical encoding of a view-dependent representation of a three-dimensional scene;
a two-dimensional display layer disposed with the static three-dimensional physical encoding in an optical stack and configured to display two-dimensional image content;
an illumination source configured to illuminate the static three-dimensional physical encoding;
wherein the display system is operable in:
a three-dimensional mode in which light output by the display system is perceived as being three-dimensional; and
a two-dimensional mode in which the light output by the display system is perceived as being two-dimensional.

12. The display system of claim 11, wherein the illumination source comprises a rear backlight behind the static three-dimensional physical encoding and an edge-lit plate disposed between the static three-dimensional physical encoding and the two-dimensional display layer, and wherein in the three-dimensional mode, the rear backlight is illuminated and the edge-lit plate is partially or completely deactivated; and wherein in the two-dimensional mode, the rear backlight is deactivated and the edge-lit plate is illuminated.

13. The display system of claim 12, wherein the edge-lit plate comprises a set of localized structures selected to produce a field in the two-dimensional mode while limiting interference with light from the rear backlight that is projected through the static three-dimensional physical encoding in the three-dimensional mode.

14. The display system of claim 11, further comprising a switchable diffuser optically coupled to the static three-dimensional physical encoding, the switchable diffuser comprising a low-haze state in the three-dimensional mode and a higher-haze state in the two-dimensional mode.

15. The display system of claim 14, further comprising a second light source, wherein the second light source equalizes brightness between the three-dimensional mode and the two-dimensional mode.

16. The display system of claim 11, wherein the static three-dimensional physical encoding comprises first regions associated with a first polarization state and second regions interleaved with the first regions and associated with a second polarization state different from the first polarization state, wherein the display system further comprises a polarization control panel configured to selectively equalize perceived brightness of the first and second regions to suppress visibility of the three-dimensional scene in the two-dimensional mode.

17. The display system of claim 11, further comprising an emissive layer disposed between the two-dimensional display layer and the static three-dimensional physical encoding that, in the two-dimensional mode, emits light to reduce contrast of the three-dimensional scene and, in the three-dimensional mode, is inactive.

18. The display system of claim 11, wherein, in the three-dimensional mode, the static three-dimensional physical encoding is in a deployed position that presents a three-dimensional scene when illuminated by the illumination source and, in the two-dimensional mode, the three-dimensional scene is in a retracted position that removes the three-dimensional scene from an optical path.

19. The display system of claim 11, wherein, in the three-dimensional mode, the static three-dimensional print comprises electrically switchable segments such that the three-dimensional scene is selectively revealed only in a designated region of the two-dimensional display layer, and wherein, in the two-dimensional mode, the three-dimensional scene is selectively concealed in a second region of the two-dimensional display layer to maintain a two-dimensional appearance.

20. The display system of claim 11, further comprises a controller configured to:
determine whether content is to be presented in the two-dimensional mode or the three-dimensional mode based on metadata associated with the content and,
to set the mode of operation of the display system based on the determination.
